(19) United States
(12) Patent Application Publication
(10) Pub. No.: US 2025/0216521 A1
(43) Pub. Date: Jul. 3, 2025

(54) SYNCHRONIZING OPERATIONS OF LIDAR AND TOF SENSORS

(71) Applicant: GM Cruise Holdings LLC, San Francisco, CA (US)

(72) Inventors: Sandeep Gangundi, San Jose, CA (US); Muhamad Muhamad Lotfy, Sammamish, WA (US); Thomas Whitfield, Alameda, CA (US)

(21) Appl. No.: 18/402,456

(22) Filed: Jan. 2, 2024

(51) Int. Cl. G01S 7/4915; G01S 7/4911; G01S 17/931

(52) U.S. Cl. CPC G01S 7/4915; G01S 7/4911; G01S 17/931

(57) ABSTRACT

Systems and techniques are provided for synchronizing sensor operations. An example method includes determining a scanning frequency of a light detection and ranging (LIDAR) sensor configured to collect data for regions of space during each scan cycle; selecting an exposure from an exposure sequence generated based on data captured by a time-of-flight (TOF) sensor to align with data from a scan from the LIDAR sensor during a scan cycle; based on the scanning frequency, a field-of-view (FOV) of the LIDAR sensor, a FOV of the TOF sensor, a location of the exposure within the exposure sequence, and/or sensor internal delays, determining a timeframe between a reference time and an alignment time during the scan cycle when the FOVs of the LIDAR sensor and the TOF sensor are aligned; and based on the timeframe, determining a time offset for triggering the TOF sensor to capture data associated with the exposure sequence.

### TECHNICAL FIELD

The present disclosure generally relates to synchronizing operations of multiple sensors. For example, aspects of the present disclosure relate to techniques and systems for triggering sensor data capturing operations of a time-of-flight sensor with sensor data capturing operations of one or more additional sensors configured to have a dynamic or changing field-of-view (FOV) coverage and/or pointing direction.

### BACKGROUND

Sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, a time-of-flight (TOF) sensor can be used to measure distance to one or more objects in an environment. As another example, a light ranging and detection (LIDAR) sensor can be used to determine ranges (variable distance) of one or more targets by directing a laser to a surface of an entity (e.g., a person, an object, a structure, an animal, etc.) and measuring the time for light reflected from the surface to return to the LIDAR. In some cases, a LIDAR (e.g., a spinning LIDAR) can be configured to rotate about an axis of the LIDAR in order to collect LIDAR data during a rotation of the LIDAR, such as a full rotation (e.g., 360 degrees) or a partial rotation of the LIDAR. The rotation of the LIDAR can allow the LIDAR to achieve a larger field-of-view (FOV) and thus collect revolutions of LIDAR data that have a greater area of coverage.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, according to some examples of the present disclosure;

FIG. 2 is a diagram illustrating an example synchronization of sensor operations performed by different sensors, according to some examples of the present disclosure;

FIG. 3 is a diagram illustrating example of sensor scans and a synchronization of exposure data captured by a time-of-flight sensor with a portion of data from the sensor scans, according to some examples of the present disclosure;

FIG. 4 is a diagram illustrating an example sensor alignment sequence, according to some examples of the present disclosure;

FIG. 5 is a flowchart illustrating an example process for synchronizing data capturing operations of multiple sensors, according to some examples of the present disclosure;

FIG. 6 is a diagram illustrating an example system architecture for implementing certain aspects described herein; and

FIG. 7 is a diagram illustrating an example of a time-of-flight sensor, according to some examples of the present disclosure.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of the subject matter of the application. However, it will be apparent that various aspects and examples of the disclosure may be practiced without these specific details. The figures and description are not intended to be restrictive.

The ensuing description provides examples and aspects of the disclosure, and is not intended to limit the scope, applicability, or configuration of the disclosure. Rather, the ensuing description of the examples and aspects of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, a time-of-flight (TOF) sensor can be used to measure distance to one or more objects in an environment. As another example, a light ranging and detection (LIDAR) sensor can be used to determine ranges (variable distance) of one or more targets by directing a laser to a surface of an entity (e.g., a person, an object, a structure, an animal, etc.) and measuring the time for light reflected from the surface to return to the LIDAR. In some cases, a LIDAR, such as a spinning LIDAR, can be configured to rotate about an axis of the LIDAR while collecting LIDAR data for different regions of space. The rotation of the LIDAR can allow the LIDAR to achieve a larger field-of-regard (FOR) based on the field-of-view (FOV) of the LIDAR from different positions during a scan cycle, and thus collect revolutions of LIDAR data that have a greater area of coverage.

In some applications, sensor data from different sensors can be fused together (e.g., combined/merged) for specific processing and/or analysis. Fusing sensor data from different sensors can be beneficial as the fused data can provide a greater amount of information and/or insights than sensor data from a single sensor. Moreover, the fused data can be processed by specific software systems (e.g., artificial intelligence (AI) models, machine learning (ML) models, software applications, etc.) to generate outputs used for various tasks. For example, fused data from different sensors can be processed by a software stack(s) of an autonomous vehicle (AV) to generate object detection outputs, recognition outputs, object tracking outputs, classification outputs, prediction outputs, planning outputs, generative outputs, control outputs, and/or navigation outputs, among other outputs.

In some cases, sensor data from different types of sensors can be fused together in part to leverage advantages from each of the different types of sensors. For example, TOF sensors can be used to obtain depth information for one or more regions of a scene and LIDARs can be used to supplement the information from the TOF sensor using state information about a scene and/or an object in a scene captured by the LIDARs, such as depth and ranging information (e.g., proximity/distance information), location information, motion information, etc. Thus, the combination of data from a TOF sensor and a LIDAR sensor can provide more information, insights, and/or advantages than either the data from the TOF sensor or the LIDAR sensor alone.

In general, to fuse data from different sensors, the data from the different sensors may need to be synchronized or aligned (e.g., have aligned or overlapping coverage), at least to some degree. In other words, to fuse data from different sensors, the data from the different sensors may need to correspond in time and space (e.g., correspond to a same region of space or have overlapping coverage). However, as previously noted, in some cases, some sensors, such as a LIDAR, can be configured to collect sensor data from different positions, angles, and/or directions as the sensor rotates about an axis of the sensor or otherwise has changes in its pointing direction. Other types of sensors may similarly collect data from different positions, directions, and/or angles. In such cases, it can be difficult to fuse data from such sensors with data from other sensors (e.g., data from a spinning LIDAR and a TOF sensor) as at least some of the data from the sensors may be misaligned in terms of the regions in space that the data cover, depict, represent, and/or measure.

For example, given the different regions of space scanned by a spinning LIDAR as the LIDAR rotates, it can be very difficult to fuse the data from the LIDAR with data from another sensor, such as a TOF sensor, as the coverage of (e.g., the regions in space sensed/measured in) the data captured by the LIDAR and the other sensor at a given time can differ. Thus, the coverage of the data captured at a given time by the other sensor and the data captured at the given time by the LIDAR from different angles of rotation can be different (e.g., misaligned) due to the different regions of space covered by the data from the other sensor and the data from the LIDAR obtained while the LIDAR rotates. As a result, at least some of the data from the LIDAR and the data from the other sensor can be misaligned and thus difficult to fuse in an accurate and/or reliable manner and/or without errors or inconsistencies in the resulting data.

Moreover, when the coverage of data captured at a given time by a sensor, such as a TOF sensor, and data captured at the given time by a spinning LIDAR are misaligned in time and/or space, the misalignment can result in motion artifacts as the depth, position, and/or motion of a target captured in the data from the sensor (e.g., the TOF sensor) and the LIDAR can differ. For example, if a TOF sensor and a spinning LIDAR obtain distance measurements for a target in a scene at different or unsynchronized times (e.g., if their data capturing operations are not synchronized), the position of the target as indicated by the distance measurements from the TOF and LIDAR sensors may appear to differ. This can result in various issues such as, for example and without limitation, inaccuracies, data fusion problems, propagated errors or inaccuracies, etc.

Described herein are systems, apparatuses, processes (also referred to as methods), and computer-readable media (collectively referred to as “systems and techniques”) for synchronizing operations of a TOF sensor(s) with operations of a LIDAR sensor(s). In some examples, the systems and techniques described herein can synchronize operations of a TOF sensor and a LIDAR sensor based on a state, setting, active FOV (e.g., a current FOV of a LIDAR with a field-of-regard (FOR) that is greater than the current FOV) of the LIDAR sensor(s). For example, the systems and techniques described herein can schedule and/or configure data capturing operations by a TOF sensor to trigger such that at least some of the data captured by the TOF sensor and data captured by a LIDAR coincide in space and time. This way, the coverage of the sensor data from the TOF sensor at a given time can at least partially overlap with (e.g., be aligned with) the data captured by the LIDAR sensor at the given time. By synchronizing the data capture operations of the TOF sensor and the LIDAR sensor, the systems and techniques described herein can reduce or avoid motion artifacts and misalignments in the captured data and allow the data from the TOF sensor and the LIDAR sensor to be fused with less or no data fusion errors, inaccuracies, and/or issues.

In some aspects, the systems and techniques described herein can synchronize data capturing operations of a TOF sensor and a spinning LIDAR sensor (or any other sensor with a FOR that is greater than a FOV of the sensor at any given time) based on various factors such as, for example and without limitation, a FOV and/or azimuth angle of the LIDAR, a frequency of rotation of the LIDAR (or any other movement and/or change in pointing direction of the LIDAR), a delay between the time a trigger the TOF sensor to initiate data capturing operations and the time that the TOF sensor begins capturing data, a delay in reading and/or processing data by the TOF sensor and/or the LIDAR sensor, respective poses of the TOF sensor and the LIDAR sensor, a pointing direction of the TOF sensor, pointing directions of the LIDAR sensor during a scan, and/or any other delays and/or timing offsets/variables. In some examples, the systems and techniques described herein can trigger a TOF sensor to capture data (e.g., a sequence of exposures and/or measurements used to generate a sequence of exposures) when a FOV and/or pointing direction of the TOF is at least partially aligned with a FOV and/or pointing direction of a moving (e.g., rotating/spinning) LIDAR sensor.

For example, in some aspects, a TOF sensor can capture a sequence of measurements (e.g., differential correlation sampling (DCS) measurements) with/using different exposure times during a sampling process. The sequence of measurements captured according to the different exposure times can be used to generate a sequence of exposures having two or more different exposure times, such as one or more long exposures (e.g., exposures having an exposure time greater than a threshold time), one or more medium exposure times (e.g., exposures having an exposure time greater than a first threshold time and less than a second threshold time), and/or short exposure times (e.g., exposures having an exposure time that is less than a threshold time). The systems and techniques described herein can trigger the TOF sensor to capture (and/or begin capturing) a particular exposure (e.g., and/or associated measurements) from the sequence of exposures at a time when the FOV and/or pointing direction of the TOF sensor and the FOV and/or pointing direction of a LIDAR sensor that captures data from different pointing directions during a scan cycle (e.g., a moving LIDAR sensor that collects data for different regions of space that together represent a FOR of the LIDAR sensor for a scan cycle) coincide. In this way, the systems and techniques described herein can synchronize the FOV (and/or pointing direction) of the TOF sensor when the TOF sensor captures information associated with a particular exposure from an exposure/sampling sequence, with the FOV (and/or pointing direction) of a moving LIDAR (e.g., a LIDAR that captures data from different pointing directions/positions) at a given time, such that the data associated with the particular exposure and LIDAR data captured by the LIDAR at the given time are aligned/synchronized in time and space.

In some examples, when triggering the TOF sensor to capture data such data the data is aligned in time and space with data captured by a moving LIDAR, the systems and techniques described herein can account for a delay between the time a signal to capture data is sent to the TOF sensor (and/or is received by the TOF sensor) and the time when the TOF sensor actual begins capturing data associated with an exposure from a sequence of exposures associated with a sampling process of the TOF sensor (and/or between the time that the TOF sensor initiates a data capture operation and actually begins capturing the data associated with the exposure). For example, the systems and techniques described herein can determine a delay between the time that a sampling process of the TOF sensor is activated (e.g., the time that a signal to capture data is sent to and/or received by the TOF sensor and/or the time that the TOF sensor initiates capturing data) and the time when the TOF begins the sampling process (e.g., begins capturing data associated with one or more exposures). The systems and techniques described herein can use the delay to determine a timing offset used to trigger the TOF sensor to activate the sampling process such that the TOF sensor captures data associated with a particular exposure while the FOV (and/or pointing direction) of the TOF sensor and the FOV (and/or pointing direction) of a moving LIDAR (and thus the coverage of the exposure and the LIDAR data) are at least partially aligned in time and space.

For example, the systems and techniques described herein can activate the TOF sensor to capture data associated with an exposure from a sampling process at a certain amount of time before the FOV (and/or pointing direction) of the TOF sensor and the FOV (and/or pointing direction) of the LIDAR are predicted to be fully or partially aligned. The amount of time can be based at least in part on the delay so that by the time that the TOF sensor begins capturing data associated with that exposure, the FOV (and/or pointing direction) of the TOF sensor is fully or partially aligned with the FOV (and/or pointing direction) of the LIDAR. In this way, the systems and techniques described herein can time the when the TOF sensor captures data associated with a particular exposure such that the FOV (and/or pointing direction) of the TOF sensor is fully or partially aligned with the FOV (and/or pointing direction) of the LIDAR (e.g., during the movement/rotation of the LIDAR) when the TOF sensor captures at least a portion of the data associated with the exposure, and thus ensure full or partial alignment of the exposure data captured by the TOF sensor and the data captured by the LIDAR while their FOVs (and/or pointing directions) are fully or partially aligned.

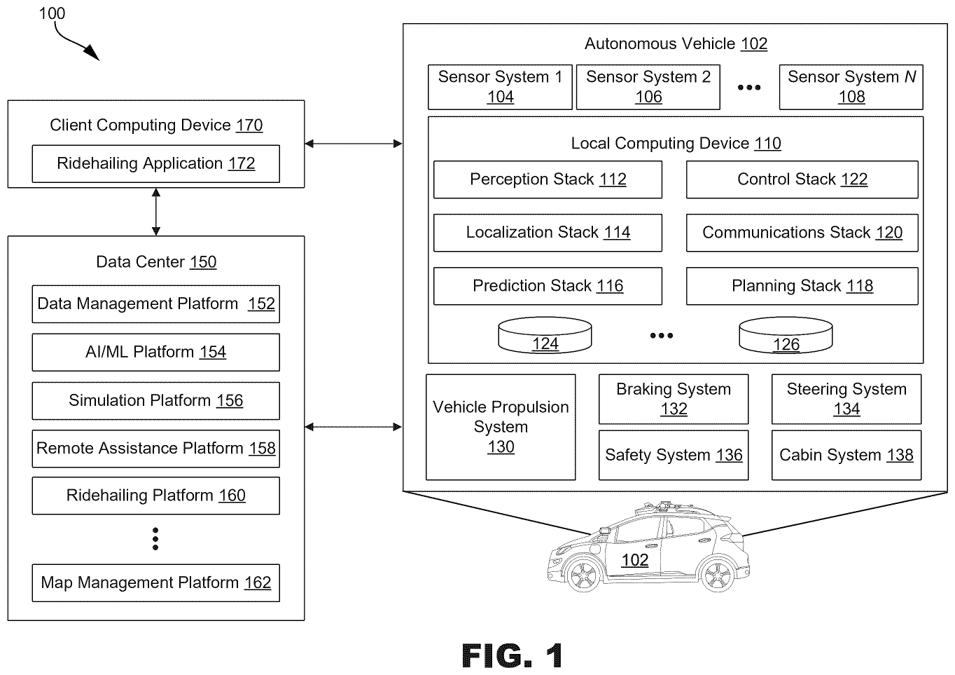

In some examples, the systems and techniques described herein can perform the alignment of data captured by one or more TOF sensors on an autonomous vehicle and one or more LIDAR sensors on the autonomous vehicle. For example, the systems and techniques described herein can synchronize the data capturing operations of a TOF sensor and a LIDAR sensor of the autonomous vehicle that are collocated, mounted within a proximity to each other, and/or mounted on a same sensor platform. FIG. 1 below describes an example autonomous vehicle environment in which the systems and techniques described herein can be implemented.

Various examples of the systems and techniques described herein are illustrated in FIG. 1 through FIG. 7 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs (e.g., AV 102), Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehailing application 172 to enable passengers to view the AV 102 in transit to a pick-up or drop-off location, and so on.

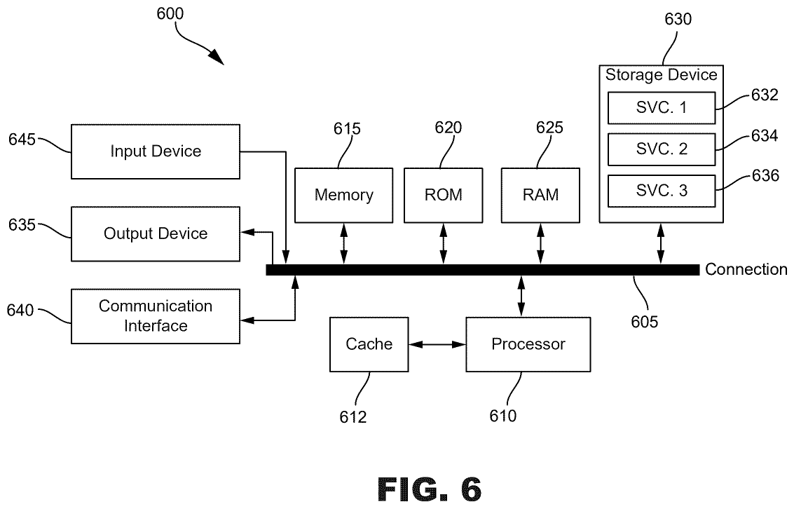

While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

In some examples, the local computing device 110 of the AV 102 can include an ADSC. Moreover, the local computing device 110 can be configured to implement the systems and techniques described herein. For example, the local computing device 110 can be configured to implement the sensor alignment described herein.

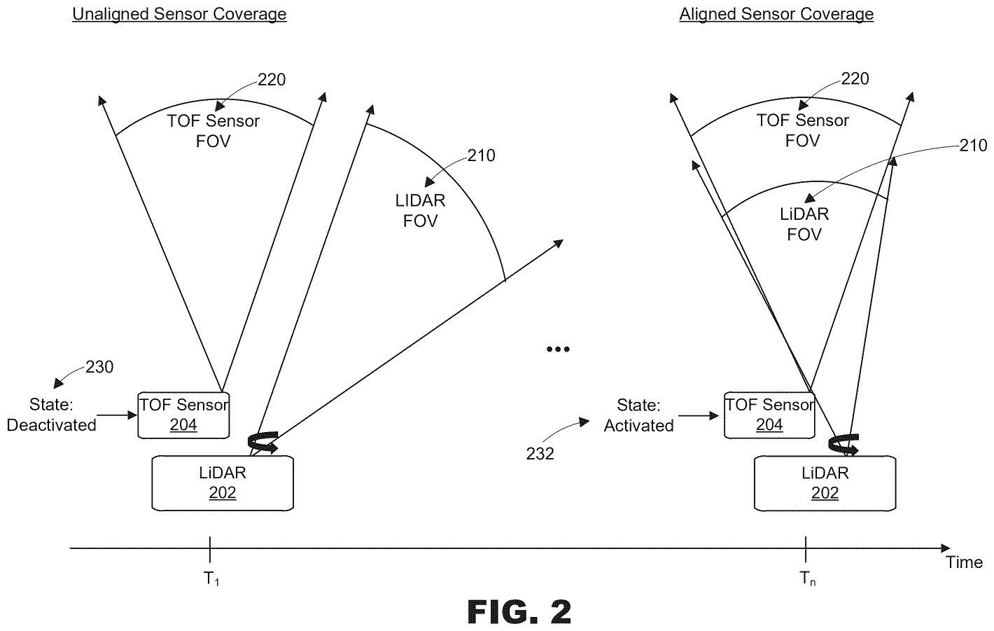

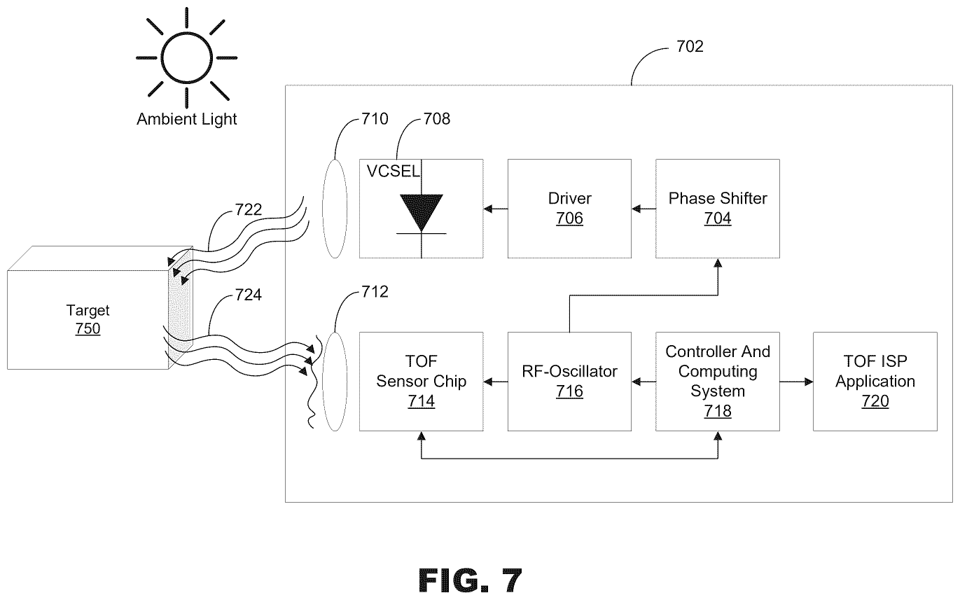

FIG. 2 is a diagram illustrating an example synchronization of sensor operations performed by different sensors, according to some examples of the present disclosure. The sensor operations can include capturing/collecting sensor data such as measurements, point cloud data, etc. In this example, the synchronization of sensor operations can include triggering a TOF sensor 204 to sample data for a particular exposure from a sequence of exposures when the FOV (and/or pointing direction) of the TOF sensor 204 is at least partially aligned with the FOV (and/or pointing direction) of a LIDAR 202 configured to collect data from different pointing directions during a scan cycle (e.g., configured to rotate during a scan cycle). In some examples, the TOF sensor 204 can include an indirect TOF LIDAR (e.g., also referred to as a flash LIDAR), which can be configured to measure a series of flashes of light and indirectly extract the range of a target from the modulation properties of the light. An example TOF sensor is illustrated in FIG. 7 and described below with respect to FIG. 7. The FOV of a sensor (e.g., LIDAR 202, TOF sensor 204) can refer to a region of space that can be sensed and/or observed by the sensor at a given moment, from a given sensing direction, and/or from a given pose of the sensor. Thus, the FOVs of a sensor when capturing data from different sensing directions, positions, and/or angles can vary in terms of the regions of space covered by the FOVs, even if the size/angle of the FOVs is/are the same as such FOVs are relative to the different directions, positions, and/or angles.

For example, the LIDAR 202 can include a movable LIDAR that moves (e.g., rotates about an axis of the LIDAR 202) as it collects LIDAR data during a scan cycle. The LIDAR 202 can have a field of regard (FOR) that represents the total area of space (e.g., of a scene) that can be measured, perceived and/or sensed by the LIDAR 202 during a scan cycle. The FOR can include a set of FOVs of the LIDAR 202 from different scanning positions, directions, and/or angles of the LIDAR 202 during the scan cycle. Each FOV of the set of FOVs can cover different regions of space, which may or may not have some overlap, based on different scanning positions, directions, and/or angles associated with the set of FOVs. The different scanning positions, directions, and/or angles of the LIDAR 202 can result from movement of the LIDAR 202 during each scan cycle, such as rotation of the LIDAR 202 about an axis of the LIDAR 202 during a scan cycle, and can result in the FOVs of the LIDAR 202 during a scan cycle covering different regions of space. During a scan cycle, the LIDAR 202 can collect LIDAR data from the different positions, directions, and/or angles based on the movement of the LIDAR 202 (e.g., via rotational motion, translational or linear motion, and/or any other type of motion) to obtain LIDAR data for an area corresponding to the FOR of the LIDAR 202, which includes the different regions of space. The FOR of the LIDAR 202 can include the FOVs of the LIDAR 202 during a scan cycle, and each of the FOVs can cover a different region of space. The LIDAR 202 can be configured to complete each scan cycle (e.g., and thus capture data for the FOR at each scan cycle) at a certain frequency, such as an amount of time that it takes the LIDAR 202 to perform a full movement (e.g., rotation, etc.) from a starting point to an ending point (e.g., which can be the same as the starting point).

In some examples, the TOF sensor 204 can be used to obtain/generate a sequence of exposures having two or more different exposure times, which can be used to generate a high dynamic range (HDR) frame. For example, the TOF sensor 204 can sample its entire FOV during each exposure period in a sequence of exposures, in order to obtain a sequence of exposures. To illustrate, the TOF sensor 204 can obtain DCS measurements during each exposure period, which can be used to create the exposures from the sequence of exposures. The sequence of exposures can include, for example and without limitation, one or more long exposures (e.g., exposures having an exposure time greater than a threshold time), one or more medium exposure times (e.g., exposures having an exposure time greater than a first threshold time and less than a second threshold time), short exposure times (e.g., exposures having an exposure time that is less than a threshold time), and/or any other exposures. Moreover, the different exposures in a sequence of exposures can be captured according to any sequence. For example, the sequence of exposures can include one or more long exposures followed by one or more short exposures, one or more short exposures followed by one or more long exposures, one or more long exposures followed by one or more medium exposures and further followed by one or more short exposures, or any other exposure sequence.

In some cases, the TOF sensor 204 can be a stationary sensor with a FOV that allows the TOF sensor 204 to measure, sense, perceive, etc., a region of space from a pose of the TOF sensor 204 (e.g., from a position and/or angle of the TOF sensor 204). In other cases, the TOF sensor 204 can include a movable TOF sensor or a TOF sensor on a platform that moves the TOF sensor 204 to obtain sensor data from the TOF sensor 204 for different areas of space (e.g., for different FOVs of the TOF sensor 204 corresponding to different positions/poses of the TOF sensor 204 resulting from movement of the TOF sensor 204). Given the pose of the TOF sensor 204, the angle of the FOV of the TOF sensor 204, the pose(s) and FOVs (e.g., the different coverage) of the LIDAR 202 during a scan cycle, and the angle of a FOV of the LIDAR 202, the FOV of the TOF sensor 204 may be misaligned with the FOV of the LIDAR 202 during one or more portions of a scan cycle of the LIDAR 202. Accordingly, the data captured by the TOF sensor 204 may not always be aligned with at least some of the data captured by the LIDAR 202 during a scan cycle of the LIDAR 202.

For example, when the FOV (and/or pointing direction) of the LIDAR 202 is not aligned with the FOV (and/or pointing direction) of the TOF sensor 204 during a scan cycle of the LIDAR 202, the data from the LIDAR 202 may not measure, depict, describe, and/or sense a same region in space (e.g., in a scene) and time as the data from the TOF sensor 204. This can result in unaligned data from the LIDAR 202 and the TOF sensor 204, which can prevent or increase the difficult in accurately or effectively fusing the data from the LIDAR 202 and the TOF sensor 204 for further processing, can result in motion artifacts between the data from the LIDAR 202 and the TOF sensor 204, etc. To ensure that the data from the TOF sensor 204, such as an exposure from an exposure sequence, is aligned with the data from the LIDAR 202 (e.g., data from the TOF sensor 204 is captured by the TOF sensor 204 while the FOV and/or pointing direction of the TOF sensor 204 is/are aligned with a FOV and/or pointing direction of the LIDAR 202), the sensor operations of the LIDAR 202 and the TOF sensor 204 can be synchronized as described herein.

The synchronization of sensor operations of the LIDAR 202 and the TOF sensor 204 can include triggering the TOF sensor 204 to capture data for a particular exposure when a FOV (and/or pointing direction) of the LIDAR 202 is at least partially aligned with the FOV (and/or pointing direction) of the TOF sensor 204 such that the data collected by the LIDAR 202 and the TOF sensor 204 at a particular time(s), when projected over a same plane in space, would fully or partially coincide (e.g., overlap in space and time). For example, the frequency of a scan cycle of the LIDAR 202 (e.g., the frequency of movement of the LIDAR 202 for a complete scan cycle, the amount of time it takes the LIDAR 202 to complete a scan cycle from beginning to end, etc.), the angle of the FOV of the LIDAR 202 from each position/angle of the LIDAR 202 during the scan cycle, the pose of the TOF sensor 204, the pose of the LIDAR 202, the angle of the FOV of the TOF sensor 204, the clocks of the LIDAR 202 and the TOF sensor 204, a global reference clock, a delay between a time when an instruction configured to trigger the TOF sensor 204 to capture data is sent to or received by the TOF sensor 204 and a time when the TOF sensor 204 begins capturing data, a timing of a particular exposure from a sequence of exposures associated with the TOF sensor 204 (e.g., generated based on data sampled by the TOF sensor 204), one or more delays of the LIDAR 202 and/or TOF sensor 204 in processing data, and/or any other timing delays and/or sensor intrinsics/extrinsics can be used to predict when a center (and/or any other point/region) of the FOV of the LIDAR 202 will align with the center (and/or any other point/region) of the FOV of the TOF sensor 204 during a scan cycle of the LIDAR 202. The predicted time can be used to determine a timing offset used to trigger the TOF sensor 204 to capture data, such as data associated with a particular exposure from a sequence of exposures, when the FOV of the TOF sensor 204 is aligned with the FOV of the LIDAR 202, so that the data from the TOF sensor 204 measures, depicts, and/or senses the same or overlapping region in space as the data from the LIDAR 202 at the time that the FOV of the LIDAR 202 is aligned with the FOV of the sensor 204. This way, the data captured by the TOF sensor 204 and the LIDAR 202 can be at least partially aligned in terms of their coverage in time and space.

For example, when the FOV of the LIDAR 202 and the FOV of TOF sensor 204 are predicted to at least partially align during a capture of data associated with an exposure from a sequence of exposures, the data from the LIDAR 202 and the exposure data from the TOF sensor 204 can depict, measure, describe, sense, and/or represent a same region in time and space or at least overlapping regions in time and space. Such alignment of captured data can allow the data from the LIDAR 202 and the TOF sensor 204 to be fused (e.g., combined/merged) together (and/or may enable better fusion accuracy and/or performance), can allow the data from the LIDAR 202 to be supplemented with information from the data from the TOF sensor 204, can reduce or prevent motion artifacts between the data from the LIDAR 202 and the TOF sensor 204, etc.

As previously noted, the LIDAR 202 can perform scans where the LIDAR 202 collects LIDAR data from a set of positions and associated FOVs in order to collect LIDAR data for various regions of space (e.g., of a scene). For example, in some cases, the LIDAR 202 can rotate (e.g., a full 360-degree rotation or a partial rotation that is less than 360 degrees) about an axis of the LIDAR 202 and obtain sensor data (e.g., point cloud data) as the LIDAR 202 rotates. As the LIDAR 202 rotates, the FOV (and pointing direction) of the LIDAR 202 can change, allowing the LIDAR 202 to capture LIDAR data associated with a FOR of the LIDAR 202 that includes different FOVs of the LIDAR 202. This way, the LIDAR 202 can obtain LIDAR data coverage for different portions of a scene.

In some examples, the LIDAR 202 and the TOF sensor 204 can be implemented by a vehicle, such as the AV 102, which may use the data from the LIDAR 202 and the TOF sensor 204 to navigate a scene, as previously described. In this example, the LIDAR 202 and the TOF sensor 204 can be positioned at respective locations on the vehicle (e.g., on the AV 102), such as collocated within a sensor platform. The vehicle (e.g., the AV 102) may use the data captured by the LIDAR 202 and the TOF sensor 204 to understand its surroundings. While the synchronization of the LIDAR 202 and the TOF sensor 204 is described herein with respect to a vehicle (e.g., AV 102) implementing such sensors to assist the vehicle to navigate a scene(s), the synchronization of the LIDAR 202 and the TOF sensor 204 can be performed to synchronize sensor operations in any other contexts and/or use cases for implementing the LIDAR 202 and the TOF sensor 204, such as a different type of transportation system, a robotic system, etc.

As further described herein, the TOF sensor 204 can be triggered to collect data associated with a particular exposure from a sequence of exposures when a FOV (and/or pointing direction) of the LIDAR 202 is at least partially aligned with a FOV (and/or pointing direction) of the TOF sensor 204. For example, as the LIDAR 202 performs a scan, the FOV (and pointing direction) of the LIDAR 202 can change to allow the LIDAR 202 to capture data from different FOVs corresponding to different angles and/or positions, which can provide coverage for different portions of a scene. The frequency of the LIDAR 202 (e.g., the frequency of rotation, the frequency of FOV changes, the frequency of a scan, etc.), the angle of the FOV of the LIDAR 202 and/or the FOV of the LIDAR 202 from a given position and/or angle during a scan, the FOV of the TOF sensor 204, the poses of the LIDAR 202 and the TOF sensor 204, triggering and/or processing delays, and/or a timing of exposures from a sequence of exposures created based on data collected by the TOF sensor 204 can be taken into account to determine when to trigger the TOF sensor 204 to trigger an operation to capture data associated with an exposure from a sequence of exposures at a time when the FOV of the LIDAR 202 is at least partially aligned with the FOV of the TOF sensor 204 so that the data from the LIDAR 202 and the data from the TOF sensor 204 associated with that exposure are at least partially aligned in time and space.

As previously noted, in some cases, the FOV of the LIDAR 202 can be deemed to be aligned with the FOV of the sensor 204 when a center of the FOV of the LIDAR 202 is aligned with a center of a FOV of the sensor 204 and/or when a pointing direction of the LIDAR 202 matches (and/or is aligned with) a pointing direction of the TOF sensor 204. In other cases, the FOV of the LIDAR 202 can be deemed to be aligned with the FOV of the sensor 204 when an angle of the FOV of the LIDAR 202 is aligned with an angle of a FOV of the sensor 204 or when the angle of the FOV of the LIDAR 202 overlaps with and/or is within the angle of the FOV of the TOF sensor 204 (or vice versa).

In some cases, a time offset (e.g., an alignment offset) of the TOF sensor 204 and the LIDAR 202 may be calculated and used to synchronize the coverage of data captured by the LIDAR 202 and the sensor 204 in order to optimize an overlap between a plane (e.g., a focal plane, etc.), FOV, pointing direction, and/or coverage of the TOF sensor 204 and a plane, FOV, pointing direction, and/or coverage of the LIDAR 202 at a particular time(s) during a scan cycle of the LIDAR 202 (e.g., and during or at some time before the TOF sensor 204 captures data associated with an exposure from the sequence of exposures). In some examples, the time offset can be determined based on the frequency of a scan cycle of the LIDAR 202 (e.g., the frequency in which the LIDAR 202 moves and collects data from a beginning of a scan cycle until an end of the scan cycle), the angle of a FOV of the LIDAR 202 from a given position/angle of the LIDAR 202 (and/or at any given time during the scan cycle), the angle of a FOV of the sensor 204 from a given position/angle, a center or center plane of the FOV of the LIDAR 202, a center or center plane of the FOV of the TOF sensor 204, a timing of a collection by the TOF sensor 204 of data associated with an exposure sequence and/or data associated with a particular exposure from the exposure sequence, one or more delays between the time when the TOF sensor 204 is triggered to capture data and the time when the TOF sensor 204 begins capturing the data, and/or any other timing and/or processing delays associated with the LIDAR 202 and/or the TOF sensor 204.

For example, the duration (and/or frequency) of a scan cycle of the LIDAR 202 and the angle of the FOV of the LIDAR 202 from any given position and/or angle of the LIDAR 202 during the scan cycle (and/or at any given time during the scan cycle) can be used to predict when the FOV (and/or pointing direction) of the LIDAR 202 will be aligned with the FOV (and/or pointing direction) of the TOF sensor 204 (e.g., when a center of the FOV of the LIDAR 202 will be aligned with the center of the FOV of the TOF sensor 204) during a period when the TOF sensor 204 captures data associated with an exposure from a sequence of exposures. Thus, the predicted time can take into account timing information for collection by the TOF sensor 204 of data associated with an exposure(s) to ensure that the FOVs (and/or pointing directions) of the LIDAR 202 and the TOF sensor 204 are at least partially aligned when the TOF sensor 204 captures data associated with the exposure(s). The time when the FOVs of the LIDAR 202 and the TOF sensor 204 are predicted to align during a data capture by the TOF sensor 204 for a particular exposure, can be used to determine a time offset, which can represent a time and/or interval of time during the scan cycle of the LIDAR 202 when the FOVs (and/or pointing directions) of the LIDAR 202 and the TOF sensor 204 will be in alignment at a period associated with an exposure from a sequence of exposures from the TOF sensor 204.

For example, if the duration (e.g., the scan period) of a scan cycle of the LIDAR 202 is n milliseconds (ms) and the exposure time of a particular exposure of interest from the TOF sensor 204 (e.g., an exposure to be aligned in time and space with the data from the LIDAR 202) is k ms, the time offset can indicate an amount of time between scan cycles of the LIDAR 202 (or between any other reference points) for the FOVs (and/or pointing directions) of the LIDAR 202 and the TOF sensor 204 to become at least partially aligned when the TOF sensor 204 begins and/or performs the collection of data associated with the particular exposure with the exposure time of k ms. In another example, if the sequence of exposures has an exposure time of y ms and the particular exposure of interest is the first exposure in the sequence of exposures, the time offset can account for the difference in time between the scan cycle duration (e.g., n ms) and the exposure time of the sequence of exposures (e.g., y ms) so that the TOF sensor 204 captures the data associated with the particular exposure when the FOVs (and/or pointing directions) of the LIDAR 202 and the TOF sensor 204 are aligned. In some cases, the time offset can also account for other timing factors and/or delays, as further described herein.

In yet another example, if the sequence of exposures has an exposure time of y ms, the first exposure in the sequence has an exposure time of z ms, and the particular exposure of interest is the second exposure in the sequence of exposures, the time offset can account for the difference in time between the scan cycle duration (e.g., n ms) and total of the exposure time of the sequence of exposures (e.g., y ms) minus the exposure time of the first exposure (e.g., z ms) so that the TOF sensor 204 captures the data associated with the second exposure (e.g., which, within the exposure sequence that includes y ms, begins after z ms after the beginning of the first exposure) when the FOVs (and/or pointing directions) of the LIDAR 202 and the TOF sensor 204 are aligned. Again, the time offset can also account for other timing factors and/or delays, as further described herein. In this way, the time offset can align (e.g., in time and space) the data capturing operations of the TOF sensor 204 for any exposure within a sequence of exposures with the data capturing operations of the LIDAR 202 when the FOVs (and/or pointing directions) of the LIDAR 202 and the TOF sensor 204 are at least partially aligned such that the data from the LIDAR 202 and the TOF sensor 204, when projected along a plane in time and space, will at least partially coincide.

The time offset can be used to trigger the TOF sensor 204 to capture data associated with a particular exposure from a sequence of exposures (or any other data) when the FOVs (and/or pointing directions) of the LIDAR 202 and the TOF sensor 204 are at least partially aligned. For example, the time offset can define a delay between data capturing operations for the TOF sensor 204 to capture data associated with a particular exposure from a sequence of exposures so the FOV (and/or pointing direction) of the TOF sensor 204 is aligned with the FOV (and/or pointing direction) of the LIDAR 202 during each scan cycle of the LIDAR 202 and each time that the TOF sensor 204 captures data associated with the particular exposure at each scan cycle of the LIDAR 202. In some cases, the time offset can also include a delay between a time when the TOF sensor 204 initiates a data capturing operation associated with a particular exposure (and/or a time when a signal is generated or received instructing the TOF sensor 204 to initiate the data capturing operation) and a time when the TOF sensor 204 starts capturing data after initiating the data capturing operation (and/or after receiving a signal to initiate the data capturing operation).

For example, if the capabilities and/or configuration of the TOF sensor 204 are such that there is a delay of n amount of time between the time when the TOF sensor 204 initiates an operation (or receives an instruction to initiate the operation) to capture data associated with a particular exposure from an exposure sequence and the time when the TOF sensor 204 actually captures the data, the amount of time defined by the time offset can be reduced by (and/or can account for) the n amount of time associated with the delay so the TOF sensor 204 is triggered to capture the data at n amount of time before the FOV (and/or pointing direction) of the LIDAR 202 is aligned with the FOV (and/or pointing direction) of the TOF sensor 204 to account for such delay. This way, the TOF sensor 204 can be triggered to initiate the operation to capture the data at n amount of time before the FOVs (and/or pointing directions) of the LIDAR 202 and the TOF sensor 204 are aligned so that the FOVs (and/or pointing directions) of the LIDAR 202 and the TOF sensor 204 are aligned when (and/or by the time that) the TOF sensor 204 actually captures/obtains the data.

In some aspects, the time offset can account for an exposure time associated with a particular exposure selected for alignment with data captured by the LIDAR 202 (e.g., the particular exposure associated with the data captured by the TOF sensor 204 when the FOVs and/or pointing directions of the LIDAR 202 and the TOF sensor 204 are at least partially aligned and the data captured by the LIDAR 202 when the FOVs and/or pointing directions of the LIDAR 202 and the TOF sensor 204 are at least partially aligned), the total exposure time of the entire sequence of exposures, the exposure time(s) of any exposures within the sequence of exposures that precede and/or follow the particular exposure selected for alignment with the data captured by the LIDAR 202, a sampling time associated with the sequence of exposures, and/or any processing delays associated with any exposures from the sequence of exposures, among other things.

For example, if the center (or any other reference portion) of the FOV (and/or the pointing direction) of the LIDAR 202 is estimated to align in time and space with the center (or any other reference portion) of the FOV (and/or the pointing direction) of the TOF sensor 204 at an alignment time of n ms within each scan cycle of the LIDAR 202 and the goal is to time the capture by the TOF sensor 204 of the data associated with a particular exposure such that the center (or any other reference portion) of the FOVs (and/or the pointing directions) of the LIDAR 202 and the TOF sensor 204 are aligned in time and space when the TOF sensor 204 has spent half of the exposure time of the particular exposure capturing the data associated with the particular exposure (e.g., when the center of the FOVs (and/or the pointing directions) of the LIDAR 202 and the TOF sensor 204 are aligned when/while the data capture of the TOF sensor 204 for the particular exposure is halfway through the exposure time), the time offset can include the alignment time of n ms (e.g., the amount of time within each cycle for the center (or any other reference portion) of the FOV (and/or the pointing direction) of the LIDAR 202 is estimated to align with the center (or any other reference portion) of the FOV (and/or the pointing direction) of the TOF sensor 204) minus half of the exposure time of the particular exposure (e.g., and optionally plus or minus any other delays or offsets described herein such as the delay between the time the TOF sensor 204 is triggered to capture data and the time that the TOF sensor 204 actually begins capturing data).

To illustrate, if the exposure time of the particular exposure is k ms and half of the exposure time is k/2 ms, the time offset can include the alignment time of n ms minus k/2 ms. This way, the time offset can be used to cause the TOF sensor 204 to start the data capture for the particular exposure early (e.g., before such alignment of FOVs (and/or the pointing directions) of the LIDAR 202 and the TOF sensor 204) so by the time the TOF sensor 204 has captured data for a period of half of the exposure time of the particular exposure, the center (or any other portion) of the FOVs (and/or the pointing directions) of the LIDAR 202 and the TOF sensor 204 are aligned.

As another example, if the goal is to time the capture by the TOF sensor 204 of the data associated with the particular exposure such that the center (or any other reference portion) of the FOVs (and/or the pointing directions) of the LIDAR 202 and the TOF sensor 204 are aligned in time and space when the TOF sensor 204 begins capturing the data associated with the particular exposure, the time offset may include the alignment time of n ms but may not be reduced by half of the exposure time (e.g., k/2 ms) as described in the previous example since the data capture by the TOF sensor 204 needs to begin when the FOVs (and/or the pointing directions) of the LIDAR 202 and the TOF sensor 204 are aligned.

As yet another example, if there are one or more exposures within the sequence of exposures that are configured to be captured by the TOF sensor 204 before the particular exposure to be aligned with the data from the LIDAR 202, the time offset can include the alignment time minus the exposure time(s) of the one or more exposures (e.g., and optionally plus or minus any delays or offsets described herein such as a delay between the time that the TOF sensor 204 is triggered to capture data and the time that the TOF sensor 204 actually begins capturing data). This way, the TOF sensor 204 can be triggered to start capturing the data for the sequence of exposures before the center (or any other reference portion) of the FOVs (and/or the pointing directions) of the LIDAR 202 and the TOF sensor 204 are aligned in time and space such that by the time that the center (or any other reference portion) of the FOVs (and/or the pointing directions) of the LIDAR 202 and the TOF sensor 204 are aligned in time and space, the TOF sensor 204 has completed capturing the data for the one or more exposures and is beginning to capture (or is ready to capture) the data for the particular exposure.

In some examples, the data from the LIDAR 202 can be aligned with any exposure from the sequence of exposures associated with the data captured by the TOF sensor 204. For example, if the sequence of exposures includes a long exposure (e.g., an exposure having an exposure time that is greater than a threshold), a medium exposure (e.g., an exposure having an exposure time that is greater than a first threshold and less than a second threshold), and a short exposure (e.g., an exposure having an exposure time that is less than a threshold), the data from the LIDAR 202 can be aligned with the data associated with the long exposure, the medium exposure, and/or the short exposure. As previously described, in some cases, depending on which exposure is aligned within the sequence of exposures, the time offset can account for any delays in completing the data capture for any exposures in the sequence of exposures that precede the exposure to be aligned. Moreover, the particular exposure from the sequence of exposures to be aligned with the LIDAR data can be selected based on one or more factors such as, for example and without limitation, the amount of information associated with each exposure, environmental factors (e.g., ambient light conditions, weather conditions, etc.), processing factors, etc.

For example, if the light/brightness levels of an environment is/are below a threshold (e.g., a darker environment), a system (e.g., local computing device 110) can select the longest exposure from the exposure sequence as the particular exposure to be aligned with the LIDAR data, since the longest exposure can capture the most amount of light/information (e.g., relative to the shorter exposures in the exposure sequence). In this example, the time offset can be calculated based in part on where the longest exposure is within the sequence of exposures (e.g., which exposures precede and/or follow the longest exposure within the sequence of exposures), to account for any delays in capturing other exposures in the exposure sequence, as previously described. As another example, if the light/brightness levels of the environment is/are above a threshold (e.g., a brighter environment), the system can select the shortest exposure (or a shorter exposure) from the exposure sequence as the particular exposure to be aligned with the LIDAR data, since the shortest exposure can capture more information (e.g., relative to the longer exposures in the exposure sequence) and/or may perform better under darker conditions. Again, the time offset can be calculated based in part on where the shortest exposure is within the sequence of exposures (e.g., which exposures precede and/or follow the shortest exposure within the sequence of exposures), to account for any delays in capturing other exposures in the exposure sequence, as previously described.

In some cases, the system can dynamically select which exposure(s) from an exposure sequence to align with the LIDAR data based on one or more conditions, such as environmental conditions. For example, if the brightness/light levels of an environment (e.g., of a brighter environment) is/are above a threshold (e.g., as determined based on data from one or more sources such as any of the sensor systems 104-108), the system can dynamically select to align a shorter exposure (e.g., relative to other exposures in the exposure sequence) with the LIDAR data since the shorter exposure may perform better than other exposures under such conditions. In this example, the system can dynamically determine or adjust the time offset for triggering the data capture operations of the TOF sensor 204 to align the shorter exposure within the exposure sequence with the LIDAR data. In some examples, the time offset can account for where the shorter exposure is within the exposure sequence and any delays associated with the data capture of any exposures within the exposure sequence that are before and/or after that shorter exposure to be aligned.

As another example, if the brightness/light levels of an environment (e.g., of a darker environment) is/are below a threshold (e.g., as determined based on data from one or more sources such as any of the sensor systems 104-108), the system can dynamically select to align a longer exposure (e.g., relative to other exposures in the exposure sequence) with the LIDAR data since the longer exposure may perform better than other exposures under such conditions. In this example, the system can dynamically determine or adjust the time offset for triggering the data capture operations of the TOF sensor 204 to align the longer exposure within the exposure sequence with the LIDAR data. In some examples, the time offset can account for where the longer exposure is within the exposure sequence and any delays associated with the data capture of any exposures within the exposure sequence that are before and/or after that longer exposure to be aligned.

To illustrate, if the time offset is configured to align data captured by the TOF sensor 204 for a shorter exposure (e.g., relative to other exposures in the exposure sequence) with the LIDAR data, and the system determines, based on data from one or more sensors (e.g., sensor systems 104-108), that the brightness/light levels of an environment has/have changed and are now below a threshold (e.g., a darker environment), the system can dynamically adjust the time offset to instead align the data associated with a longer exposure in the exposure sequence to the LIDAR data (as opposed to the data associated with the shorter exposure) since the longer exposure may capture more information and/or provide a better performance in the darker environment.

In some cases, the time offset can be adjusted if the LIDAR 202 (or the TOF sensor 204) experiences drift. For example, if there is a change to the frequency of the LIDAR 202, a pose of the LIDAR 202, a FOV of the TOF sensor 204, a pose of the TOF sensor 204, and/or any other misalignment or cause for misalignment between the FOVs (and/or the pointing directions) of the LIDAR 202 and the TOF sensor 204, the time offset can become increasingly off or inaccurate over time (e.g., the FOVs and/or the pointing directions of the LIDAR 202 and the TOF sensor 204 can become more and more out of synchronization). The system (e.g., the local computing device 110) can detect such drift and trigger an adjustment of the time offset to correct the drift and ensure that the FOVs (and/or the pointing directions) of the LIDAR 202 and the TOF sensor 204 remain aligned over time during a given portion of each scan cycle of the LIDAR 202.

In some examples, the system can detect the drift by comparing the angles of the FOVs of the LIDAR 202 and the TOF sensor 204 at a given time during a scan cycle of the LIDAR 202 and/or from a given position/angle of the LIDAR 202 during the scan cycle. In other examples, the system can detect the drift by comparing the centers (or any other points/regions) of the FOVs of the LIDAR 202 and the TOF sensor 204 at a given time during a scan cycle of the LIDAR 202 and/or from a given position/angle of the LIDAR 202 during the scan cycle.

For example, the system can compare the angle of coverage of data from the TOF sensor 204 and data from the LIDAR 202 corresponding to a time when the FOVs of the LIDAR 202 and the TOF sensor 204 were predicted to be aligned (e.g., based on the time offset) to determine whether the FOVs of the LIDAR 202 and the TOF sensor 204 (and/or the data from the LIDAR 202 and the TOF sensor 204 at a predicted time of alignment) are misaligned and should be corrected. The system can determine a compensation amount (e.g., an amount of time to compensate for the drift), which can be added to or subtracted from the time offset to yield an adjusted time offset that realigns the FOVs of the LIDAR 202 and the TOF sensor 204. The compensation amount can be added to the time offset if the time offset is determined to trigger the TOF sensor 204 to capture data associated with a particular exposure after the FOVs of the LIDAR 202 and the TOF sensor 204 are no longer aligned (e.g., the TOF sensor 204 captures data late relative to the alignment of the FOVs of the LIDAR 202 and the TOF sensor 204), or subtracted from the time offset if the time offset is determined to trigger the TOF sensor 204 to capture data before the FOVs of the LIDAR 202 and the TOF sensor 204 are aligned (e.g., the TOF sensor 204 captures data early relative to the alignment of the FOVs of the LIDAR 202 and the TOF sensor 204).

In some cases, the compensation amount used to correct drift can be calculated based on metadata of the data captured by the LIDAR 202 and/or the TOF sensor 204. For example, in some cases, the data from the LIDAR 202 can include metadata (e.g., in a header of the sensor data, etc.) indicating a timestamp when the data was captured and/or the angle of coverage of the data. Such metadata can be used to determine any misalignment between the FOVs of the LIDAR 202 and the TOF sensor 204 at a time when the time offset triggers the TOF sensor 204 to capture data associated with a particular exposure, and a compensation amount that can be used to adjust the time offset to realign the FOVs of the LIDAR 202 and the TOF sensor 204 at a time when the adjusted time offset triggers the TOF sensor 204 to capture data associated with the particular exposure.

As shown in FIG. 2, at time T₁, the FOV 210 of the LIDAR 202 is not aligned with the FOV 220 of the TOF sensor 204. Accordingly, at time T₁, the data capture operation of the TOF sensor 204 is not executed due to the misalignment between the FOV 210 of the LIDAR 202 and the FOV 220 of the TOF sensor 204. The FOV 210 of the LIDAR 202 and the FOV 220 of the TOF sensor 204 are not aligned at T₁ at least in part because of the positions, angles, and/or pointing directions of the LIDAR 202 and the TOF sensor 204 at T₁. Thus, as shown in this example, the FOV 220 of the TOF sensor 204 and the FOV 210 of the LIDAR 202 are unaligned, and the state 230 of the TOF sensor 204 is deactivated 230 meaning that the TOF sensor 204 is not actively capturing data at T₁. The state 230 of the TOF sensor 204 (e.g., deactivated or activated) as used herein refers to whether the sensor 204 is capturing data (and/or has initiated a data capture operation).

In some examples, the alignment of the data capturing of the LIDAR 202 and the TOF sensor 204 can be based on a synchronizing calculation (e.g., the time offset) used to determine when to trigger the TOF sensor 204 to capture data associated with a particular exposure from an exposure sequence, so the data captured by the TOF sensor 204 (and/or a pointing direction or line-of-sight of the TOF sensor 204) is at least partially aligned with the data captured by the LIDAR 202 (and/or a pointing direction or line-of-sight of the LIDAR 202) such that the data from the TOF sensor 204 is captured while the FOV (and/or the pointing direction or line-of-sight) of the TOF sensor 204 at least partially aligns with the FOV (and/or the pointing direction or line-of-sight) of the LIDAR 202. For example, the synchronization calculation can be used to determine a time offset that can be used to trigger the TOF sensor 204 to capture data associated with a particular exposure when the FOV (and/or the pointing direction or line-of-sight) of the TOF sensor 204 is aligned with the FOV (and/or the pointing direction or line-of-sight) of the LIDAR 202 (e.g., when centers of the FOVs of the LIDAR 202 and TOF sensor 204 are aligned).

In some examples, the synchronization process can determine an amount of time it takes the LIDAR 202 to complete a scan cycle. For example, the synchronization process can determine the amount of time it takes the LIDAR 202 to move (e.g., rotate) during a scan cycle (e.g., based on a LIDAR frequency and/or scan period) from a start location, position, and/or angle of the LIDAR 202 at a beginning (or any other start reference point) of a scan cycle until an end location, position, and/or angle of the LIDAR 202 at an end (or any other end reference point) of the scan cycle. The synchronization process can use the amount of time it takes the LIDAR 202 to complete a scan cycle to determine an interval of time between a time when the center of the FOV (or any other portion) of the LIDAR 202 is aligned with the center of the FOV (or any other portion) of the TOF sensor 204 during a scan cycle and the time when the center of the FOV (or any other portion) of the LIDAR 202 will be aligned with the center of the FOV (or any other portion) of the TOF sensor 204 during a next scan cycle. Such interval of time can be used to determine a time offset that can be used to trigger the TOF sensor 204 to capture data associated with a particular exposure from an exposure sequence when the FOV of the TOF sensor 204 is aligned with the FOV of the LIDAR 202.

At time T₂, the FOV 220 of the TOF sensor 204 is aligned with the FOV 210 of the LIDAR 202. The TOF sensor 204 can be triggered to capture data associated with a particular exposure from an exposure sequence (or group of exposures) at time T₂ when the FOV 220 of the TOF sensor 220 is aligned with the FOV 210 of the LIDAR 202 based on a time offset, as further described herein. In some examples, when the FOV 210 of the LIDAR 202 is aligned with the FOV 220 of the TOF sensor 204, the scan/sweep of the LIDAR 202 can be aligned with and/or come across the center of the FOV 220 of the TOF sensor 204, resulting in an optimal sampling time for the TOF sensor 204 so the data from the TOF sensor 204 covers a same or overlapping region in space as the data from the LIDAR 202. Here, since the FOV 220 of the TOF sensor 204 and the FOV 210 of the LIDAR 202 are aligned, the state 232 of the TOF sensor 204 can be activated meaning that the TOF sensor 204 is triggered to capture the data associated with the particular exposure at T₂ when the FOV 210 of the LIDAR 202 and the FOV 220 of the TOF sensor 204 are aligned.

In some examples, the time offset can be calculated to ensure that the FOV 220 of the TOF sensor 204 is aligned with the FOV 210 of the LIDAR 202 at any time relative to an exposure period of the particular exposure, such as a beginning of the exposure period, a middle of the exposure period, or any other period. For example, the time offset can be calculated to ensure that the FOV 220 of the TOF sensor 204 is aligned with the FOV 210 of the LIDAR 202 at or by the beginning of the exposure period associated with the particular exposure (e.g., at the beginning of the particular exposure). As another example, the time offset can be calculated to ensure that the FOV 220 of the TOF sensor 204 is aligned with the FOV 210 of the LIDAR 202 at or by the time that the data capture operations of the TOF sensor 204 are halfway through the exposure period associated with the particular exposure (e.g., at the middle of the particular exposure). In this example, the time offset can account for any delays from the beginning of the exposure period to the middle of the exposure period to ensure that the TOF sensor 204 is triggered at or by the time that the data capture operations of the TOF sensor 204 are halfway through the exposure period associated with the particular exposure.

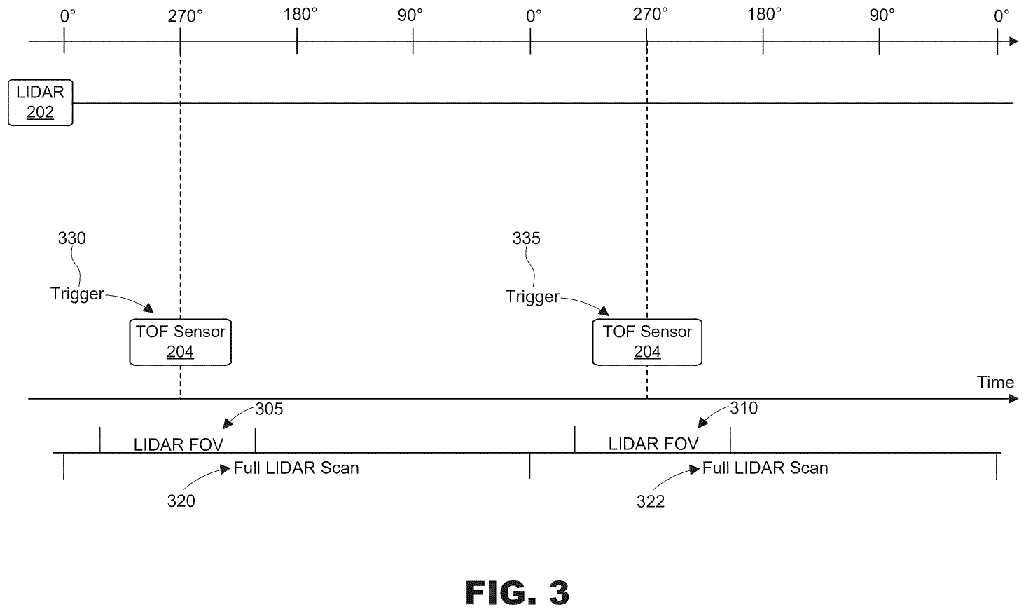

FIG. 3 is a diagram illustrating example of LIDAR scans 320 and 322 and a synchronization of exposure data captured by the TOF sensor 204 with a portion of the data from the LIDAR scans 320 and 322. In this example, the TOF sensor 204 can be triggered to capture data associated with a particular exposure from an exposure sequence while the FOVs (and/or pointing directions) of the LIDAR 202 and the TOF sensor 204 are aligned. The top trace shows the LIDAR 202, which in this example rotates 360 degrees while collecting sensor data during each scan cycle of the LIDAR 202 (e.g., each scan cycle involves 360 degrees of rotation). When the FOV of the LIDAR 202 is aligned with the FOV of the TOF sensor 204, a computing device (e.g., local computing device 110 of AV 102) can trigger (e.g., via an instruction) the TOF sensor 204 to capture data associated with the particular exposure. The computing device can trigger the TOF sensor 204 to capture the data based on one or more time offsets calculated as previously described. In some cases, the computing device can trigger the TOF sensor 204 to initiate an operation to capture data prior to the FOV of the TOF sensors 204 and the FOV of the LIDAR 202 being aligned. In some examples, the amount of time before the alignment of FOVs for triggering the initiation of the operation to capture data by the TOF sensor 204 can be at least partly based on a delay of the TOF sensor 204 from the time that such operation is initiated until the time when the TOF sensor 204 captures/obtains the data associated with the particular exposure.

The computing device (e.g., local computing device 110) may determine the trigger times based on the LIDAR sensor frequency. The LIDAR frequency describes the frequency at which the LIDAR completes a scan cycle and/or the rate in which the FOV of the LIDAR 202 changes during a scan cycle. The TOF sensor 204 can be instructed to capture data at a frequency corresponding to a time offset estimated to cause the TOF sensor 204 to capture the data associated with a particular exposure when the FOV of the TOF sensor 204 is aligned with the FOV of the LIDAR 202.

For example, as shown in FIG. 3, the computing device can send a trigger 330 to the TOF sensor 204 that triggers the TOF sensor 204 to capture the data associated with the particular exposure (e.g., the exposure from the exposure sequence to be aligned) when a center of the FOV 305 of the LIDAR 202 is at 270 degrees while performing the full LIDAR scan 320, and another trigger 335 when the center of the FOV of the LIDAR 202 is again at 270 degrees during the full LIDAR scan 322 captured in a subsequent scan cycle (e.g., in a subsequent LIDAR scan). When the center of the FOV of the LIDAR 202 is at 270 degrees during the full LIDAR scan 320 and the full LIDAR scan 322, the center of the FOV of the LIDAR 202 and the center of the FOV of the TOF sensor 204 are predicted to be aligned. Therefore, the data associated with the particular exposure captured by the TOF sensor 204 when the center of the FOV of the LIDAR 202 is at 270 degrees will be in alignment with the data captured by the LIDAR 202 (e.g., data from the full LIDAR scan) when the center of the FOV of the LIDAR 202 is at 270 degrees.

The degrees at which the FOVs are aligned and the size of the LIDAR scans shown in FIG. 3 are merely illustrative examples and can differ in other examples. Moreover, the number of sensors aligned with the LIDAR 202 can include more than one sensor. The TOF sensor 204 in FIG. 3 is merely one illustrative example.

The trigger 330 and the trigger 335 can each include a signal configured to trigger the TOF sensor 204 to capture data. In some example, each trigger (e.g., trigger 330, trigger 335) can include one or more instructions and/or commands configured to trigger the TOF sensor 204 to capture data. In some cases, each trigger can include a same or respective time offset that indicates when the TOF sensor 204 should initiate an operation to capture data. For example, the trigger 330 can include a time offset calculated for the TOF sensor 204 that indicates when the TOF sensor 204 should initiate a data capturing operation during the full LIDAR scan 320 (e.g., during the associated scan cycle). The trigger 335 can include the same time offset or a different time offset, which can indicate when the TOF sensor 204 should initiate a data capturing operation during the full LIDAR scan 322 (e.g., during the associated scan cycle). In some cases, the triggers 330 and 335 can include the same time offset. In other cases, the triggers 330 and 335 can include different time offsets, such as time offsets specific to respective scan cycles.

In some cases, the trigger 330 can be generated and/or sent to the TOF sensor 204 before a predicted time of FOV alignment for a LIDAR scan, and used to trigger data capturing operations by the TOF sensor 204 when the FOV of the TOF sensor 204 and the FOV of the LIDAR 202 are aligned during the LIDAR scan. In some examples, the trigger 330 can be used by the TOF sensor 204 to trigger data capturing operations at specific times and/or intervals during one or more LIDAR scans. In other examples, a trigger can be sent to the TOF sensor 204 for each LIDAR scan (e.g., rather than sending to the TOF sensor 204 a trigger used in multiple LIDAR scans to align data capturing operations of the TOF sensor 204) to provide a time offset to the TOF sensor 204 for each LIDAR scan.

In some cases, the trigger 330 can be sent to the TOF sensor 204 a certain amount before the center of the FOV of the LIDAR 202 is aligned with the center of the FOV of the TOF sensor 204 to account for any delays between the time that the TOF sensor 204 receives the trigger 330 and the time that the TOF sensor 204 begins capturing data and/or to account for any delays between the time when the TOF sensor 204 captures (and/or begins capturing) data for one or more exposures in an exposure sequence and the time when the TOF sensor 204 captures (and/or begins capturing) data for a particular exposure in the exposure sequence selected for alignment with data from a LIDAR scan. Thus, the timing for sending the trigger 330 can be based on a time offset when the FOV of the LIDAR 202 is predicted to be aligned with the FOV of the TOF sensor 204 relative to any portion of the particular exposure, and a determined delay between the time that the TOF sensor 204 receives the trigger 330 and the time that the TOF sensor 204 begins capturing data.

For example, if a computing device determines that there is a 1 ms delay between the time that the TOF sensor 204 receives the trigger 330 and the time that the TOF sensor 204 begins capturing data, and the time offset indicates that the FOV of the LIDAR 202 and the FOV of the TOF sensor 204 are aligned every 50 ms, the computing device can send the trigger 330 to the TOF sensor 204 every 49 ms, which includes the 50 ms indicated in the time offset minus the amount of delay determined for the TOF sensor 204 (e.g., the 1 ms). As another example, if the trigger indicates a time offset and the TOF sensor 204 is configured to use the trigger 330 to trigger data capturing operations during multiple LIDAR scans (e.g., rather than receiving and using a trigger for each LIDAR scan), the time offset can include an amount/interval of time it takes for the FOV of the LIDAR 202 to be aligned with the FOV of the TOF sensor 204 between LIDAR scans (e.g., from when the FOV of the LIDAR 202 is aligned with the FOV of the TOF sensor 204 during the LIDAR scan 320 and the FOV of the LIDAR 202 is aligned with the FOV of the TOF sensor 204 during the LIDAR scan 322) minus a delay between the time that the TOF sensor 204 initiates a data capturing operation and the time that the TOF sensor 204 actually begins capturing sensor data. In some examples, the delay can be further increased if there are one or more exposures in the exposure sequence before the exposure(s) being aligned to the data from the LIDAR scan. For example, if the particular exposure being aligned is after an exposure having an exposure time of 5 ms, the delay subtracted from the time offset can include the 5 ms to ensure that the TOF sensor 204 begins capturing data in time to complete the exposure having the 5 ms exposure time and begin capturing data for the particular exposure when (and/or by the time that) the FOVs of the LIDAR 202 and the TOF sensor 204 are aligned.

Similarly, in some examples, the trigger 332 can be sent to the TOF sensor 204 a certain amount before the center of the FOV of the LIDAR 202 is aligned with the center of the FOV of the TOF sensor 204 to account for a delay between the time that the TOF sensor 204 receives the trigger 332 and the time that the TOF sensor 204 begins capturing data. In some cases, the delay used to calculate when to send the trigger 332 to the TOF sensor 204 can also include a delay in capturing data associated with any exposures within an exposure sequence that are before the exposure being aligned with the LIDAR data. This way, the TOF sensor 204 can be triggered to start capturing data for the other exposures so by the time the FOVs of the LIDAR 202 and the TOF sensor 204 are aligned, the TOF sensor 204 is capturing (or is ready to capture) the data for the particular exposure being aligned.

While the previous examples describe aligning the center of the FOVs of the LIDAR 202 and the TOF sensor 204, such alignment is merely one illustrative example provided for explanation purposes. As one of ordinary skill in the art will recognize from the present disclosure, other alignment schemes are possible and contemplated herein. For example, in some cases, the alignment scheme can include aligning a boundary of the LIDAR FOV 305 and/or the LIDAR FOV 310 with a center or a boundary of the FOV of the TOF sensor 204. For example, in some cases, as a boundary of the LIDAR FOV 305 approaches a boundary of the FOV of the TOF sensor 204 (before the FOVs overlap) during a LIDAR scan, the TOF sensor 204 can be triggered to begin capturing data when such FOV boundaries are aligned (e.g., overlap) such that the alignment/overlap between the LIDAR FOV 305 and the FOV of the TOF sensor 204 increase as the LIDAR scan continues and the TOF sensor 204 captures data (e.g., the data captured during an exposure period associated with a particular exposure being aligned). As another example, in some cases, as a boundary of the LIDAR FOV 305 approaches a center (or any other portion) of the FOV of the TOF sensor 204 during a LIDAR scan, the TOF sensor 204 can be triggered to begin capturing data when such the boundary of the LIDAR FOV and the center (or any other portion) of the FOV of the TOF sensor 204 are aligned (e.g., overlap) such that the alignment/overlap between the LIDAR FOV 305 and the FOV of the TOF sensor 204 increase as the LIDAR scan continues and the TOF sensor 204 captures data (e.g., the data captured during an exposure period associated with a particular exposure being aligned).

Non-limiting examples of alignment reference points that can be used to align data from the LIDAR 202 and the TOF sensor 204 include a pointing direction and/or line-of-sight, an FOV sub-angle, an FOV boundary, an FOV center, among others. Moreover, the alignment can be configured to trigger the TOF sensor 204 to initiate the capture of data at any point within an exposure period of a particular exposure when the FOVs of the LIDAR 202 and the TOF sensor 204 are aligned. For example, the time offset used for alignment can be estimated to trigger the TOF sensor 204 to begin an exposure period associated with the particular exposure when the FOVs of the LIDAR 202 and the TOF sensor 204 are aligned. In another example, the time offset used for alignment can be estimated to trigger the TOF sensor 204 to begin capturing data such that a portion, such as half, of the exposure period associated with the particular exposure has completed or will complete when the FOVs of the LIDAR 202 and the TOF sensor 204 are aligned.

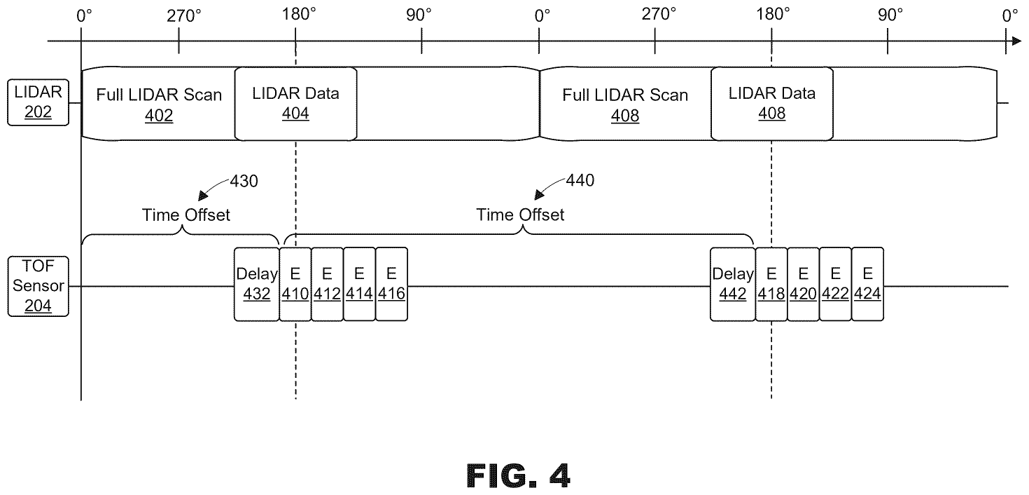

FIG. 4 is a diagram illustrating an example sensor alignment sequence 400. In this example, the LIDAR 202 can obtain a full LIDAR scan 402 during a first scan cycle and another full LIDAR scan 406 during a subsequent scan cycle. The full LIDAR scan 402 can include LIDAR data 404 that is at least partially aligned in time and space with data captured by the TOF sensor 204 for a particular exposure (e.g., exposure 410) from an exposure sequence that includes multiple exposures (e.g., exposures 410, 412, 414, 416). Similarly, the full LIDAR scan 406 can include LIDAR data 408 that is at least partially aligned in time and space with data captured by the TOF sensor 204 for a particular exposure (e.g., exposure 418) from an exposure sequence that includes multiple exposures (e.g., exposures 418, 420, 422, 424). In some examples, the exposures 410, 412, 414, 416 can include a same exposure time or different exposure times. For example, in some cases, the exposures 410, 412, 414, 416 can include one or more long exposures, one or more short exposures, and/or one or more medium exposures. To illustrate, in some cases, the exposures 410 and 412 can represent long exposures while the exposures 414 and 416 can represent short exposures.

Moreover, the sensor alignment can select any exposure (or group of exposures) from the sequence of exposures (e.g., exposures 410, 412, 414, 416) to align with the LIDAR data 404. In some cases, the exposure (or group of exposures) selected for alignment with the LIDAR data 404 can be determined based on an exposure time(s) of any exposure from the exposure sequence. For example, if the exposure sequence (e.g., exposures 410, 412, 414, 416) includes two long exposures and two short exposures, the sensor alignment can select to align the LIDAR data in any given scan cycle of the LIDAR 202 with a long exposure (or both long exposures) from the exposure sequence, a short exposure (or both short exposures) from the exposure sequence, a long exposure and a short exposure from the exposure sequence (e.g., a long exposure and a short exposure adjacent to each other within the exposure sequence, etc.), or any other exposure(s). The decision to select one or more long, short, or medium exposures to align with the LIDAR data 404 can be made based on one or more factors such as, for example and without limitation, one or more exposure times and associated amount of information contained in one or more corresponding exposures, environmental conditions (e.g., brightness/light levels, etc.), the environment where the LIDAR 202 and the TOF sensor 204 are implemented (e.g., an urban environment, a rural environment, a highway environment, etc.), the location of exposures within the exposure sequence, and/or any other factors.

In some examples, a time offset 430 can be used to trigger the TOF sensor 204 to capture the data associated with the exposure 410 at a time that ensures that such data is aligned in time and space with the LIDAR data 404 from the full LIDAR scan 402. In this example, the time offset 430 can be calculated based on the frequency of the LIDAR 202, the FOV of the LIDAR 202, the FOV of the TOF sensor 204, the pose of the LIDAR 202, the pose of the TOF sensor 204, the rate and/or angle of change of the FOV of the LIDAR 202 during each scan cycle, a delay 432, and/or any other factors. For example, an angle of coverage (e.g., an azimuth angle) of the FOV of the TOF sensor 204 from a particular position of the TOF sensor 204 can be determined based on the configured FOV of the TOF sensor 204 and the position of the TOF sensor 204. In some examples, the angle of coverage can be determined relative to a reference point, such as the LIDAR 202 or any other region in space. The information about the angle of coverage of the TOF sensor 204 can be used to predict when the FOV of the TOF sensor 204 will at least partially overlap with the FOV of the LIDAR 202.

For example, the configured FOV of the LIDAR 202 and the frequency (and/or scan period) of each scan cycle of the LIDAR 202 (and/or the rate and/or angle of change of the configured FOV of the LIDAR 202 throughout a LIDAR scan cycle) as well as the information about the angle of coverage of the TOF sensor 204 can be used to determine a time offset 430 that indicates when the FOV of the LIDAR 202 and the FOV of the TOF sensor 204 will fully or partially align/overlap. To illustrate, the configured FOV of the LIDAR 202 and the frequency of each scan cycle of the LIDAR 202 (and/or the rate and/or angle of change of the configured FOV of the LIDAR 202 throughout a LIDAR scan cycle) as well as the information about the angle of coverage of the TOF sensor 204 can be used to determine an amount of time (e.g., the time offset 430) within a scan cycle (or relative to any other reference point such as a global clock) it is predicted to take for the FOV of the LIDAR 202 and the FOV of the TOF sensor 204 to become fully or partially aligned/overlapping.

In some cases, the time offset 430 can be used to trigger the TOF sensor 204 to capture data to ensure the alignment of the exposure 410 and the LIDAR data 404 from the LIDAR scan 402. In some examples, the time offset 430 can be reduced by a delay 432 representing an amount of time between the TOF sensor 204 triggering data capture operations and the data capture operations actually beginning. This way, the TOF sensor 204 can be triggered to capture the exposure 410 before the time offset 430 to account for the delay 432 and ensure that the TOF sensor 204 begins capturing the exposure 410 by the time that the FOVs of the LIDAR 202 and the TOF sensor 204 are aligned.

In some cases, if the exposure selected for alignment with the LIDAR data is another exposure (or group of exposures) that is after the exposure 410 in the exposure sequence (e.g., exposures 410, 412, 414, 416), the time offset 430 can be adjusted (e.g., relative to the time offset 430 if the exposure 410 is the first exposure in the exposure sequence) to include or account for the exposure time associated with each exposure that is before the selected exposure (the exposure selected for alignment) within the exposure sequence. For example, if the exposure selected for alignment with the LIDAR data is exposure 416, the time offset 430 can be decreased to include or account for the exposure times of exposure 410, exposure 412, and exposure 414, so that the TOF sensor 204 is triggered to capture the data associated with the exposure 410, exposure 412, and exposure 414 before the FOVs of the LIDAR 202 and the TOF sensor 204 become aligned and completes capturing the data associated with the exposure 410, exposure 412, and exposure 414 by the time that the FOVs of the LIDAR 202 and the TOF sensor 204 become aligned (e.g., at the desired alignment point), so the TOF sensor 204 can begin (or is in the process of) capturing the data associated with the exposure 416 by the time (or some time before) that the FOVs of the LIDAR 202 and the TOF sensor 204 are at least partly aligned.

In some cases, the system can use the time offset 430 to align data capture operations of the TOF sensor 204 at each of multiple scan cycles of the LIDAR 202. In other cases, the system can calculate another time offset that can be used as an offset for triggering the TOF sensor 204 to trigger data capture operations for one or more scan cycles (e.g., a time offset used to align exposure data captured by the TOF sensor 204 with LIDAR data from one scan cycle to another). For example, in some cases, the time offset 430 can represent an initial time offset used to align the exposure 410 with the LIDAR data 404, and a different time offset(s) can be used to align data captured by the TOF sensor 204 during one or more subsequent scan cycles of the LIDAR 202 with LIDAR data from the one or more subsequent scan cycles.

To illustrate, in the example shown in FIG. 4, the system can calculate a time offset 440 used to trigger the TOF sensor 204 to capture data associated with the exposure 418 from a next exposure sequence (e.g., exposures 418, 420, 422, 424) so that the data associated with the exposure 418 (or any other exposure) is aligned with LIDAR data 408 from the next full LIDAR scan 406 (and, in some cases, any additional LIDAR scan) obtained in the next scan cycle of the LIDAR 202. The time offset 440 can be the same or different than the time offset 430. In some examples, the time offset 440 can define an amount of time to wait from a reference point/time to the next time that the TOF sensor 204 should be triggered to capture data associated with the exposure 418 (or any other exposure) so that such data is aligned with the LIDAR data 408 from the full LIDAR scan 406. The reference point/time can include, for example and without limitation, the time when the TOF sensor 204 was triggered to capture the previous exposure data (e.g., exposure 410) during the previous scan cycle of the LIDAR 202, an interval between the end of the time offset 430 used in the previous scan cycle of the LIDAR 202 until the next time that the TOF sensor 204 should be triggered, a global clock, a clock of the TOF sensor 204 and/or the LIDAR 202, the time when the TOF sensor 204 begins or completes capturing the data associated with the exposure 410 in the previous scan cycle of the LIDAR 202, the beginning or end of the exposure time associated with the exposure 410 from the previous scan cycle of the LIDAR 202, a time within the exposure time (e.g., a time in the middle of the exposure time or any other time within the exposure time) associated with the exposure 410 from the previous scan cycle of the LIDAR 202, a time at the end of the exposure sequence (e.g., exposures 410, 412, 414, 416) from the previous scan cycle of the LIDAR 202, or any other reference point/time.

The time offset 440 can be calculated based on the frequency of the LIDAR 202 and any other delays and/or offsets such as, for example, a delay 442 between the time that the TOF sensor 204 is triggered to capture data associated with the exposure 418 (e.g., the time when the TOF sensor 204 receives a triggering instruction or the time when such triggering instruction is generated or sent to the TOF sensor 204), a component delay associated with the TOF sensor 204 (e.g., a processing delay, a data readout delay, a data publishing delay, etc.), and/or any other delays and/or offsets. In some cases, one or more delays and/or offsets used to calculate the time offset 440 can depend on the reference point/time used for the time offset 440. For example, if the time offset 440 is calculated relative to the time when (e.g., the time offset 440 includes an interval from the time when) the TOF sensor 204 begins capturing the data associated with the exposure 410 in the previous scan cycle of the LIDAR 202, the one or more delays and/or offsets can include a time delay between the end of the time offset 430 from the previous scan cycle and the time when the TOF sensor 204 begins capturing such data. As another example, if the time offset 440 is calculated relative to the time when (e.g., the time offset 440 includes an interval from the time when) the TOF sensor 204 completes capturing the data associated with the exposure 410 in the previous scan cycle of the LIDAR 202, the one or more delays and/or offsets can include a time delay between the end of the time offset 430 from the previous scan cycle (or the time when the TOF sensor 204 begins capturing such data) and the time when the TOF sensor 204 completes capturing such data.

In some examples, the exposures 418, 420, 422, 424 can include a same exposure time or different exposure times. For example, in some cases, the exposures 418, 420, 422, 424 can include one or more long exposures, one or more short exposures, and/or one or more medium exposures. To illustrate, in some cases, the exposures 418 and 420 can represent long exposures while the exposures 422 and 424 can represent short exposures. Moreover, the sensor alignment can select any exposure (or group of exposures) from the sequence of exposures (e.g., exposures 418, 420, 422, 424) to align with the LIDAR data. In some cases, the exposure (or group of exposures) selected for alignment with the LIDAR data 408 can be determined based on an exposure time(s) of any exposure from the exposure sequence. For example, if the exposure sequence (e.g., exposures 418, 420, 422, 424) includes two long exposures and two short exposures, the sensor alignment can select to align the LIDAR data in any given scan cycle of the LIDAR 202 with a long exposure (or both long exposures) from the exposure sequence, a short exposure (or both short exposures) from the exposure sequence, a long exposure and a short exposure from the exposure sequence (e.g., a long exposure and a short exposure adjacent to each other within the exposure sequence, etc.), or any other exposure(s). The decision to select one or more long, short, or medium exposures to align with the LIDAR data 408 can be made based on one or more factors such as, for example and without limitation, one or more exposure times and associated amount of information contained in one or more corresponding exposures, environmental conditions (e.g., brightness/light levels, etc.), the environment where the LIDAR 202 and the TOF sensor 204 are implemented (e.g., an urban environment, a rural environment, a highway environment, etc.), the location of exposures within the exposure sequence, and/or any other factors.

In the examples described above with respect to FIG. 4, the alignment was discussed with respect to the first exposure from each exposure sequence captured during each scan cycle of the LIDAR 202. However, such examples are merely illustrative examples provided for explanation purposes. In other examples, the LIDAR data captured by the LIDAR 202 during any given scan cycle can be aligned with any other exposure in an exposure sequence. For example, in some cases, the time offset 440 can include an interval calculated to align the LIDAR data 408 from the full LIDAR scan 406 with exposure 420, exposure 422, and/or exposure 424. In such cases, the time offset 440 can be adjusted (e.g., reduced) to start earlier (e.g., to account for delays in capturing any prior exposure(s) in the exposure sequence) so that the TOF sensor 204 begins capturing (or is in the process of capturing or starting to capture) the data associated with exposure 420, exposure 422, and/or exposure 424 when (and/or by the time that) the FOVs of the LIDAR 202 and the TOF sensor 204 are aligned.

To illustrate, to align the exposure 420 with the LIDAR data 408 (instead of aligning the exposure 418 with the LIDAR data 408 as described in the previous example), the time offset 440 can be reduced by the exposure time of the exposure 418 that is before the exposure 420 in the exposure sequence (exposures 418, 420, 422, 424) so the TOF sensor 204 is triggered to start and complete capturing data associated with the exposure 418 by the time when the FOVs of the LIDAR 202 and the TOF sensor 204 are aligned (and/or at some point when the FOVs of the LIDAR 202 and the TOF sensor 204 are aligned), since the exposure time of the exposure 418 represents a delay between the time when the TOF sensor 204 is triggered to start data capture operations and the time when the TOF sensor 204 captures the data associated with the exposure 420.

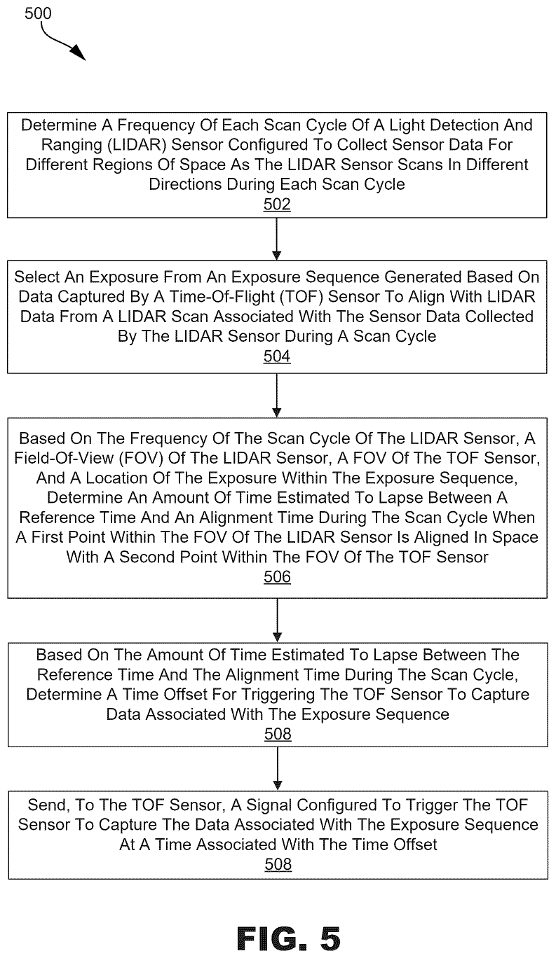

FIG. 5 is a flowchart illustrating an example process 500 for synchronizing data capturing operations of multiple sensors, according to some examples of the present disclosure. At block 502, the process 500 can include determining a frequency of each scan cycle of LIDAR sensor (e.g., LIDAR 202) configured to collect sensor data for different regions of space as the LIDAR sensor scans in different directions during each scan cycle. In some examples, the frequency of each scan cycle can include an amount of time it takes the LIDAR sensor to complete a scan cycle and/or a scanning rate implemented by the LIDAR sensor during a scan cycle.

At block 504, the process 500 can include selecting an exposure from an exposure sequence generated based on data captured by a TOF sensor (e.g., TOF sensor 204) to align with LIDAR data from a LIDAR scan associated with the sensor data collected by the LIDAR sensor during a scan cycle. For example, the process 500 can include determining which exposure from the exposure sequence should be aligned with data collected by the LIDAR sensor during the LIDAR scan. The exposure can be selected before the LIDAR sensor performs or completes the scan cycle. Moreover, the scan cycle can include a scan cycle to be implemented by the LIDAR sensor. Thus, the LIDAR scan can include a scan that the LIDAR sensor has not yet performed or completed, and the LIDAR data can include data that has not yet been captured by the LIDAR sensor or that the LIDAR sensor has not completed capturing.

In some examples, the exposure can include a long exposure (e.g., an exposure having an exposure time that is greater than a exposure time threshold), a short exposure (e.g., an exposure having an exposure time that is less than an exposure time threshold), or a medium exposure (e.g., an exposure having an exposure time that is greater than a first exposure time threshold and less than a second exposure time threshold). In some cases, selecting the exposure can include selecting a single exposure from the exposure sequence. In other cases, selecting the exposure can include selecting a group of exposures from the exposure sequence.

At block 506, the process 500 can include, based on the frequency of the scan cycle of the LIDAR sensor, a FOV of the LIDAR sensor, a FOV of the TOF sensor, and a location of the exposure within the exposure sequence, determining an amount of time estimated to lapse between a reference time and an alignment time during the scan cycle when a first point within the FOV of the LIDAR sensor is aligned in space with a second point within the FOV of the TOF sensor.

In some cases, the FOV of the LIDAR sensor can be determined based on a pose of the LIDAR sensor, a pointing direction of the LIDAR sensor at any given time, an angle of coverage (e.g., an azimuth angle) of the LIDAR sensor from any given pointing direction, and/or a configuration of the LIDAR sensor. Similarly, the FOV of the TOF sensor can be determined based on a pose of the TOF sensor, a pointing direction of the TOF sensor at any given time, an angle of coverage (e.g., an azimuth angle) of the TOF sensor from any given pointing direction, and/or a configuration of the TOF sensor.

In some examples, the FOVs of the LIDAR sensor and the TOF sensor can include pointing directions of the LIDAR sensor and the TOF sensor. In some cases, the amount of time estimated to lapse between a reference time and an alignment time during the scan cycle when a first point within the FOV of the LIDAR sensor is aligned in space with a second point within the FOV of the TOF sensor can be determined based on the scan frequency (and/or scan frequency rate) of the LIDAR sensor, the pointing direction of the TOF sensor, and/or the pointing direction of the LIDAR sensor at one or more times within the scan cycle.

In some examples, the reference time can include a beginning of the scan cycle, a beginning of a previous scan cycle associated with the LIDAR sensor, a time within the previous scan cycle, a time from a reference clock, a time when the TOF sensor was triggered to capture data during one or more previous scan cycles associated with the LIDAR sensor, and/or a time associated with a data capture operation performed by the TOF sensor during the previous scan cycle.

In some examples, the first point within the FOV of the LIDAR sensor can be on a first plane that intersects a center of the FOV of the LIDAR sensor or extends from a vertex of a first angle of the FOV of the LIDAR sensor, and the second point within the FOV of the TOF sensor can be on a second plane that intersects a center of the FOV of the TOF sensor or extends from a vertex of a second angle of the FOV of the TOF sensor.

At block 508, the process 500 can include determining, based on the amount of time estimated to lapse between the reference time and the alignment time during the scan cycle, a time offset for triggering the TOF sensor to capture data associated with the exposure sequence.

At block 510, the process 500 can include sending, to the TOF sensor, a signal configured to trigger the TOF sensor to capture the data associated with the exposure sequence at a time associated with the time offset. In some examples, the time associated with the time offset can include the amount of time estimated to lapse between a reference time and an alignment time during the scan cycle when a first point within the FOV of the LIDAR sensor is aligned in space with a second point within the FOV of the TOF sensor.

In some aspects, the process 500 can include determining a time delay between a time when the TOF sensor initiates an operation to capture the data and a different time when the TOF sensor captures the data. In some examples, the time offset can include the amount of time estimated to lapse between the reference time and the alignment time during the scan cycle minus the time delay.

In some examples, the time offset can be configured to trigger the TOF sensor to capture data associated with the exposure for a portion of an exposure time associated with the exposure, at or by the alignment time during the scan cycle when the first point within the FOV of the LIDAR sensor is aligned in space with the second point within the FOV of the TOF sensor. In some cases, the portion of the exposure time can include half of the exposure time. In other cases, the portion of the exposure time can include less or more than half of the exposure time.

In some aspects, the time offset can be configured to trigger the TOF sensor to start capturing data associated with the exposure at or by the alignment time during the scan cycle when the first point within the FOV of the LIDAR sensor is aligned in space with the second point within the FOV of the TOF sensor.

In some cases, the exposure can be located sequentially after one or more exposures from the exposure sequence, and determining the amount of time estimated to lapse between the reference time and the alignment time during the scan cycle can include determining an exposure time of each of the one or more exposures, and/or determining a time delay between a time when the TOF sensor initiates an operation to capture the data and a different time when the TOF sensor captures the data. In some examples, the time offset can include the exposure time of each of the one or more exposures and/or the time delay.

In some aspects, the LIDAR sensor and the TOF sensor can be mounted on a vehicle, such as AV 102.

FIG. 6 illustrates an example processor-based system with which some aspects of the subject technology can be implemented. For example, processor-based system 600 can be any computing device making up local computing device 110, data center 160, a passenger device executing the ridehailing application 172, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 635 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

FIG. 7 illustrates an example TOF system, according to some examples of the present disclosure. As shown, the TOF system can include a TOF sensor 702. In some examples, the TOF sensor 702 can include, represent, implement, and/or be the same as the TOF sensor 204. The TOF sensor 702 can work by illuminating a scene or target with a transmitted light 722 (e.g., transmitted signal, modulated output/signal, incident light, or emitted light/signal) and observing (e.g., receiving, capturing or recording, sensing, measuring, analyzing, etc.) a received light 724 (e.g., received signal, backscattered light/signal, or reflected signal/light) that is backscattered (e.g., reflected) by a target 750. In the illustrative example of FIG. 7, the TOF sensor 702 can include a local oscillator clock 716 (e.g., radio frequency (RF) oscillator), a phase shifter 704 at a transmission channel, a driver 706, a light source 708, and a transmit optical system 710.

In some cases, the local oscillator clock 716 can include any applicable type of oscillator clock, otherwise referred to as a radio frequency (RF)-oscillator clock. The local oscillator clock 716 can generate a clock signal that can be used to modulate an output signal of the TOF sensor 702 (e.g., transmitted light 722) and/or to demodulate the TOF pixels on the sensor array (TOF sensor chip 714). In some aspects, the phase shifter 704 can receive the clock signal generated by the local oscillator clock 716 and delay it for purposes of creating a phase adjusted input. While the phase shifter 704 is shown as being implemented on the transmitting channel, in various examples, the phase shifter 704 can be implemented in the receiving channel of the TOF sensor 702. For example, the phase shifter 704 can be implemented in the receiving channel to affect modulation of the signal generated by a light source 708. In another example, the phase shifter 704 can be implemented between the TOF sensor chip 714 and the local oscillator clock 716 or directly integrated with the TOF sensor chip 714.

In some examples, a driver 706 can receive the phase adjusted clock signal from the phase shifter 704 and modulate the signal based on the phase adjusted clock signal to generate a modulated output (e.g., transmitted light 722) from the light source 708. In some examples, the illumination of the TOF sensor 702 can be generated by the light source 708. The light source 708 can include, for example and without limitation, a solid-state laser (e.g., a laser diode (LD), a vertical-cavity surface-emitting laser (VCSEL), etc.), a light-emitting diode (LED), etc.), a lamp, and/or any other light emitter or light emitting device.

In some aspects, the transmitted light 722 (e.g., modulated output from the light source 708) can pass through the transmit optical system 710 and be transmitted towards the target 750 in a scene. In some cases, the target 750 can include any type of target, surface, interface, and/or object such as, for example and without limitation, a human, an animal, a vehicle, a tree, a structure (e.g., a building, a wall, a shelter such as a bus stop shelter, etc.), an object, a surface, a device, a material with a refractive index that allows at least some light (e.g., transmitted light 722, ambient light, etc.) to be reflected/backscattered from the material, and/or any other target, surface, interface, and/or object in a scene.

In the illustrative example of FIG. 7, the TOF sensor 702 includes a receiving optical system 712, a TOF sensor chip 714, and a controller and computing system 718 supporting an application 720. When the transmitted light 722 (e.g., an RF modulated infrared (IR) optical signal with an equal wave front) interacts with the target 750, at least some of the transmitted light 722 can be reflected back towards the TOF sensor 702 as a received light 724 (e.g., backscattered signal, light incident on the TOF sensor 702, etc.).

In some examples, the received light 724 passes through the receiving optical system 712 to the TOF sensor chip 714. The received light 724 can include the RF modulated IR optical signal backscattered with different time-of-flight delays. The different TOF delays in the received light 724 can represent, include, or otherwise encode 3D information of the target 750. As used herein, 3D information of a target can include applicable information defining characteristics of a target in 3D space. For example, 3D information of a target can include range information that describes a distance between a reference and the target or a portion of the target.

In some examples, the light that is received by and/or enters (e.g., the light incident on) the receiving optical system 712 and/or the TOF sensor chip 714 can include a reflected component. In other examples, the light that is received by and/or enters (e.g., the light incident on) the receiving optical system 712 and/or the TOF sensor chip 714 can include a reflected component as well as an ambient component. In some examples, the distance (e.g., depth) information may be embedded in, measured from, and/or defined by the reflected component or may only be embedded in the reflected component.

In some examples, TOF depth image processing methods can include collecting correlation samples (CSs) to calculate a phase estimate. For example, correlation samples of a TOF pixel and/or image can be collected at one or more time points, such as sequential time points, and at different phase shift/offset conditions. The signal strength of the correlation samples varies with the different phase shifts. As such, the samples output from the TOF pixel and/or image can have different values.

In some cases, the TOF sensor chip 714 can detect varying TOF delays in the received light 724. As follows, the TOF sensor chip 714 can communicate with the controller and computing system 718 to process the TOF delays and generate 3D information based on the TOF delays.

In some aspects, the controller and computing system 718 can support an application 720 that performs further signal processing and controls various functional aspects, for example, based on the 3D information. For example, the application 720 can control or facilitate control of an AV (e.g., AV 102 as illustrated in FIG. 1) based on the 3D information.

As explained, the light from a modulated light source (e.g., transmitted light 722) is backscattered by the target 750 in the field of view of the TOF sensor 702, and the phase shift between the transmitted light 722 and the received light 724 can be measured. By measuring the phase shift at multiple modulation frequencies, a depth value for each pixel can be calculated. In one illustrative example, based on a continuous-wave (CW) method, the TOF sensor 702 can take multiple samples per measurement, e.g., with each sample phase-stepped by, e.g., 90 degrees, for a total of four samples (however, the present technology is not limited to a 4 phased-stepped implementation). Using this technique, the TOF sensor 702 can calculate the phase angle between illumination and reflection and the distance associated with the target 750. In some cases, a reflected amplitude (A) and an offset (B) can have an impact on the depth measurement precision or accuracy. Moreover, the TOF sensor 702 can approximate the depth measurement variance. In some cases, the reflected amplitude (A) can be a function of the optical power, and the offset (B) can be a function of the ambient light and residual system offset. In some examples, the offset (B) can include one or more calibration/compensation offsets as further described herein.

When the received light 724 arrives at a TOF sensor of the TOF sensor 702 (e.g., through a lens of the TOF sensor 702), each pixel of the TOF sensor demodulates the RF-modulated light 724 generated by electrons and concurrently integrates the photogenerated charges in pixel capacitors at multiple phase shift steps or phase offsets at multiple phase windows. In this way, the TOF sensor 702 can acquire a set of raw TOF data. The TOF sensor 702 can process the raw TOF data. For example, the TOF sensor 702 can demodulate the time-of-flight and use the time-of-flight to calculate the distance from the TOF sensor 702 to the target 750. In some cases, the TOF sensor 702 can also generate an amplitude image of active light (A) and a grayscale image of passive light or offset part (B) of the active light.

In some examples, the distance demodulation can establish the basis for estimating depth by the TOF sensor 702. In some cases, there can be multiple capacitors and multiple integral windows with a phase difference π under each pixel of the TOF sensor of the TOF sensor 702. In one sampling period, the pixel can be designed with electronics and capacitors that can process and accumulate the differential charge or samples. This process is called differential correlation sampling (DCS), and may be used as a method to cancel or minimize the offset (B) from the correlation results. In an example implementation of a 4-DCS method, the capacitors can sample a signal four times at four phases such as 0°, 90°, 180° and 270° phases. The TOF sensor 702 can use the sample results (e.g., DCS1, DCS2, DCS3, DCS4 sampled at different phase shifts between the transmitted light 722 and the received light 724 to calculate the distance of the target 750 (relative to the TOF sensor 702) based on the phase shift.

In some examples, the TOF sensor 702 can measure a distance for every pixel to generate a depth map. In some cases, a depth map can include a collection of points (e.g., each point is also known as a voxel). In some cases, the depth map can be rendered in a two-dimensional (2D) representation or image. In other cases, a depth map can be rendered in a 3D space as a collection of points or point cloud. In some examples, the 3D points can be mathematically connected to form a mesh onto which a texture surface can be mapped.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: memory; and one or more processors coupled to the memory, the one or more processors being configured to: determine a frequency of each scan cycle of a light detection and ranging (LIDAR) sensor configured to collect sensor data for different regions of space as the LIDAR sensor scans in different directions during each scan cycle; select an exposure from an exposure sequence generated based on data captured by a time-of-flight (TOF) sensor to align with LIDAR data from a LIDAR scan associated with the sensor data collected by the LIDAR sensor during a scan cycle; based on the frequency of the scan cycle of the LIDAR sensor, a field-of-view (FOV) of the LIDAR sensor, a FOV of the TOF sensor, and a location of the exposure within the exposure sequence, determine an amount of time estimated to lapse between a reference time and an alignment time during the scan cycle when a first point within the FOV of the LIDAR sensor is aligned in space with a second point within the FOV of the TOF sensor; based on the amount of time estimated to lapse between the reference time and the alignment time during the scan cycle, determine a time offset for triggering the TOF sensor to capture data associated with the exposure sequence; and send, to the TOF sensor, a signal configured to trigger the TOF sensor to capture the data associated with the exposure sequence at a time associated with the time offset.

Aspect 2. The system of Aspect 1, wherein the one or more processors are configured to: determine a time delay between a time when the TOF sensor initiates an operation to capture the data and a different time when the TOF sensor captures the data, wherein the time offset comprises the amount of time estimated to lapse between the reference time and the alignment time during the scan cycle minus the time delay.

Aspect 3. The system of any of Aspects 1 or 2, wherein the time offset is configured to trigger the TOF sensor to capture data associated with the exposure for a portion of an exposure time associated with the exposure at or by the alignment time during the scan cycle when the first point within the FOV of the LIDAR sensor is aligned in space with the second point within the FOV of the TOF sensor.

Aspect 4. The system of Aspect 3, wherein the portion of the exposure time comprises half of the exposure time.

Aspect 5. The system of Aspect 3, wherein the portion of the exposure time comprises less or more than half of the exposure time.

Aspect 6. The system of any of Aspects 1 to 5, wherein the time offset is configured to trigger the TOF sensor to start capturing data associated with the exposure at or by the alignment time during the scan cycle when the first point within the FOV of the LIDAR sensor is aligned in space with the second point within the FOV of the TOF sensor.

Aspect 7. The system of any of Aspects 1 to 6, wherein the reference time comprises a beginning of the scan cycle, a beginning of a previous scan cycle associated with the LIDAR sensor, a time within the previous scan cycle, a time from a reference clock, a time when the TOF sensor was triggered to capture data during one or more previous scan cycles associated with the LIDAR sensor, and a time associated with a data capture operation performed by the TOF sensor during the previous scan cycle.

Aspect 8. The system of any of Aspects 1 to 7, wherein the exposure is located sequentially after one or more exposures from the exposure sequence, and wherein determining the amount of time estimated to lapse between the reference time and the alignment time during the scan cycle comprises: determining an exposure time of each of the one or more exposures; and determining a time delay between a time when the TOF sensor initiates an operation to capture the data and a different time when the TOF sensor captures the data, wherein the time offset comprises the exposure time and the time delay.

Aspect 9. The system of any of Aspects 1 to 8, wherein the first point within the FOV of the LIDAR sensor is on a first plane that intersects a center of the FOV of the LIDAR sensor or extends from a vertex of a first angle of the FOV of the LIDAR sensor, and wherein the second point within the FOV of the TOF sensor is on a second plane that intersects a center of the FOV of the TOF sensor or extends from a vertex of a second angle of the FOV of the TOF sensor.

Aspect 10. A method comprising: determining a frequency of each scan cycle of a light detection and ranging (LIDAR) sensor configured to collect sensor data for different regions of space as the LIDAR sensor scans in different directions during each scan cycle; selecting an exposure from an exposure sequence generated based on data captured by a time-of-flight (TOF) sensor to align with LIDAR data from a LIDAR scan associated with the sensor data collected by the LIDAR sensor during a scan cycle; based on the frequency of the scan cycle of the LIDAR sensor, a field-of-view (FOV) of the LIDAR sensor, a FOV of the TOF sensor, and a location of the exposure within the exposure sequence, determining an amount of time estimated to lapse between a reference time and an alignment time during the scan cycle when a first point within the FOV of the LIDAR sensor is aligned in space with a second point within the FOV of the TOF sensor; based on the amount of time estimated to lapse between the reference time and the alignment time during the scan cycle, determining a time offset for triggering the TOF sensor to capture data associated with the exposure sequence; and sending, to the TOF sensor, a signal configured to trigger the TOF sensor to capture the data associated with the exposure sequence at a time associated with the time offset.

Aspect 11. The method of Aspect 10, further comprising: determining a time delay between a time when the TOF sensor initiates an operation to capture the data and a different time when the TOF sensor captures the data, wherein the time offset comprises the amount of time estimated to lapse between the reference time and the alignment time during the scan cycle minus the time delay.

Aspect 12. The method of any of Aspects 10 or 11, wherein the time offset is configured to trigger the TOF sensor to capture data associated with the exposure for a portion of an exposure time associated with the exposure at or by the alignment time during the scan cycle when the first point within the FOV of the LIDAR sensor is aligned in space with the second point within the FOV of the TOF sensor.

Aspect 13. The method of Aspect 12, wherein the portion of the exposure time comprises half of the exposure time.

Aspect 14. The method of Aspect 12, wherein the portion of the exposure time comprises less or more than half of the exposure time.

Aspect 15. The method of any of Aspects 10 to 14, wherein the time offset is configured to trigger the TOF sensor to start capturing data associated with the exposure at or by the alignment time during the scan cycle when the first point within the FOV of the LIDAR sensor is aligned in space with the second point within the FOV of the TOF sensor.

Aspect 16. The method of any of Aspects 10 to 15, wherein the reference time comprises a beginning of the scan cycle, a beginning of a previous scan cycle associated with the LIDAR sensor, a time within the previous scan cycle, a time from a reference clock, a time when the TOF sensor was triggered to capture data during one or more previous scan cycles associated with the LIDAR sensor, and a time associated with a data capture operation performed by the TOF sensor during the previous scan cycle.

Aspect 17. The method of any of Aspects 10 to 16, wherein the exposure is located sequentially after one or more exposures from the exposure sequence, and wherein determining the amount of time estimated to lapse between the reference time and the alignment time during the scan cycle comprises: determining an exposure time of each of the one or more exposures; and determining a time delay between a time when the TOF sensor initiates an operation to capture the data and a different time when the TOF sensor captures the data, wherein the time offset comprises the exposure time and the time delay.

Aspect 18. The method of any of Aspects 10 to 17, wherein the first point within the FOV of the LIDAR sensor is on a first plane that intersects a center of the FOV of the LIDAR sensor or extends from a vertex of a first angle of the FOV of the LIDAR sensor, and wherein the second point within the FOV of the TOF sensor is on a second plane that intersects a center of the FOV of the TOF sensor or extends from a vertex of a second angle of the FOV of the TOF sensor.

Aspect 19. The method of any of Aspects 10 to 18, wherein the LIDAR sensor and the TOF sensor are mounted on a vehicle.

Aspect 20. A non-transitory computer-readable medium having stored thereon instructions which, when executed by one or more processors, cause the one or more processors to perform a method according to any of Aspects 10 to 18.

Aspect 21. A vehicle comprising a light detection and ranging (LIDAR) sensor; a time-of-flight (TOF) sensor; and a computing device configured to perform a method according to any of Aspects 10 to 18.

Aspect 22. A system comprising means for performing a method according to any of Aspects 10 to 18.

What is claimed is:

1. A system comprising:
a memory; and
one or more processors coupled to the memory, the one or more processors being configured to:
determine a frequency of each scan cycle of a light detection and ranging (LIDAR) sensor configured to collect sensor data for different regions of space as the LIDAR sensor scans in different directions during each scan cycle;
select an exposure from an exposure sequence generated based on data captured by a time-of-flight (TOF) sensor to align with LIDAR data from a LIDAR scan associated with the sensor data collected by the LIDAR sensor during a scan cycle;
based on the frequency of the scan cycle of the LIDAR sensor, a field-of-view (FOV) of the LIDAR sensor, a FOV of the TOF sensor, and a location of the exposure within the exposure sequence, determine an amount of time estimated to lapse between a reference time and an alignment time during the scan cycle when a first point within the FOV of the LIDAR sensor is aligned in space with a second point within the FOV of the TOF sensor;
based on the amount of time estimated to lapse between the reference time and the alignment time during the scan cycle, determine a time offset for triggering the TOF sensor to capture data associated with the exposure sequence; and
send, to the TOF sensor, a signal configured to trigger the TOF sensor to capture the data associated with the exposure sequence at a time associated with the time offset.

2. The system of claim 1, wherein the one or more processors are configured to:
determine a time delay between a time when the TOF sensor initiates an operation to capture the data and a different time when the TOF sensor captures the data, wherein the time offset comprises the amount of time estimated to lapse between the reference time and the alignment time during the scan cycle minus the time delay.

3. The system of claim 1, wherein the time offset is configured to trigger the TOF sensor to capture data associated with the exposure for a portion of an exposure time associated with the exposure at or by the alignment time during the scan cycle when the first point within the FOV of the LIDAR sensor is aligned in space with the second point within the FOV of the TOF sensor.

4. The system of claim 3, wherein the portion of the exposure time comprises half of the exposure time.

5. The system of claim 3, wherein the portion of the exposure time comprises less or more than half of the exposure time.

6. The system of claim 1, wherein the time offset is configured to trigger the TOF sensor to start capturing data associated with the exposure at or by the alignment time during the scan cycle when the first point within the FOV of the LIDAR sensor is aligned in space with the second point within the FOV of the TOF sensor.

7. The system of claim 1, wherein the reference time comprises a beginning of the scan cycle, a beginning of a previous scan cycle associated with the LIDAR sensor, a time within the previous scan cycle, a time from a reference clock, a time when the TOF sensor was triggered to capture data during one or more previous scan cycles associated with the LIDAR sensor, and a time associated with a data capture operation performed by the TOF sensor during the previous scan cycle.

8. The system of claim 1, wherein the exposure is located sequentially after one or more exposures from the exposure sequence, and wherein determining the amount of time estimated to lapse between the reference time and the alignment time during the scan cycle comprises:
determining an exposure time of each of the one or more exposures; and
determining a time delay between a time when the TOF sensor initiates an operation to capture the data and a different time when the TOF sensor captures the data, wherein the time offset comprises the exposure time and the time delay.

9. The system of claim 1, wherein the first point within the FOV of the LIDAR sensor is on a first plane that intersects a center of the FOV of the LIDAR sensor or extends from a vertex of a first angle of the FOV of the LIDAR sensor, and wherein the second point within the FOV of the TOF sensor is on a second plane that intersects a center of the FOV of the TOF sensor or extends from a vertex of a second angle of the FOV of the TOF sensor.

10. A method comprising:
determining a frequency of each scan cycle of a light detection and ranging (LIDAR) sensor configured to collect sensor data for different regions of space as the LIDAR sensor scans in different directions during each scan cycle;
selecting an exposure from an exposure sequence generated based on data captured by a time-of-flight (TOF) sensor to align with LIDAR data from a LIDAR scan associated with the sensor data collected by the LIDAR sensor during a scan cycle;
based on the frequency of the scan cycle of the LIDAR sensor, a field-of-view (FOV) of the LIDAR sensor, a FOV of the TOF sensor, and a location of the exposure within the exposure sequence, determining an amount of time estimated to lapse between a reference time and an alignment time during the scan cycle when a first point within the FOV of the LIDAR sensor is aligned in space with a second point within the FOV of the TOF sensor;
based on the amount of time estimated to lapse between the reference time and the alignment time during the scan cycle, determining a time offset for triggering the TOF sensor to capture data associated with the exposure sequence; and
sending, to the TOF sensor, a signal configured to trigger the TOF sensor to capture the data associated with the exposure sequence at a time associated with the time offset.

11. The method of claim 10, further comprising:
determining a time delay between a time when the TOF sensor initiates an operation to capture the data and a different time when the TOF sensor captures the data, wherein the time offset comprises the amount of time estimated to lapse between the reference time and the alignment time during the scan cycle minus the time delay.

12. The method of claim 10, wherein the time offset is configured to trigger the TOF sensor to capture data associated with the exposure for a portion of an exposure time associated with the exposure at or by the alignment time during the scan cycle when the first point within the FOV of the LIDAR sensor is aligned in space with the second point within the FOV of the TOF sensor.

13. The method of claim 12, wherein the portion of the exposure time comprises half of the exposure time.

14. The method of claim 12, wherein the portion of the exposure time comprises less or more than half of the exposure time.

15. The method of claim 10, wherein the time offset is configured to trigger the TOF sensor to start capturing data associated with the exposure at or by the alignment time during the scan cycle when the first point within the FOV of the LIDAR sensor is aligned in space with the second point within the FOV of the TOF sensor.

16. The method of claim 10, wherein the reference time comprises a beginning of the scan cycle, a beginning of a previous scan cycle associated with the LIDAR sensor, a time within the previous scan cycle, a time from a reference clock, a time when the TOF sensor was triggered to capture data during one or more previous scan cycles associated with the LIDAR sensor, and a time associated with a data capture operation performed by the TOF sensor during the previous scan cycle.

17. The method of claim 10, wherein the exposure is located sequentially after one or more exposures from the exposure sequence, and wherein determining the amount of time estimated to lapse between the reference time and the alignment time during the scan cycle comprises:
determining an exposure time of each of the one or more exposures; and
determining a time delay between a time when the TOF sensor initiates an operation to capture the data and a different time when the TOF sensor captures the data, wherein the time offset comprises the exposure time and the time delay.

18. The method of claim 10, wherein the first point within the FOV of the LIDAR sensor is on a first plane that intersects a center of the FOV of the LIDAR sensor or extends from a vertex of a first angle of the FOV of the LIDAR sensor, and wherein the second point within the FOV of the TOF sensor is on a second plane that intersects a center of the FOV of the TOF sensor or extends from a vertex of a second angle of the FOV of the TOF sensor.

19. The method of claim 10, wherein the LIDAR sensor and the TOF sensor are mounted on a vehicle.

20. A non-transitory computer-readable medium having stored thereon instructions which, when executed by one or more processors, cause the one or more processors to:
determine a frequency of each scan cycle of a light detection and ranging (LIDAR) sensor configured to collect sensor data for different regions of space as the LIDAR sensor scans in different directions during each scan cycle;
select an exposure from an exposure sequence generated based on data captured by a time-of-flight (TOF) sensor to align with LIDAR data from a LIDAR scan associated with the sensor data collected by the LIDAR sensor during a scan cycle;
based on the frequency of the scan cycle of the LIDAR sensor, a field-of-view (FOV) of the LIDAR sensor, a FOV of the TOF sensor, and a location of the exposure within the exposure sequence, determine an amount of time estimated to lapse between a reference time and an alignment time during the scan cycle when a first point within the FOV of the LIDAR sensor is aligned in space with a second point within the FOV of the TOF sensor;
based on the amount of time estimated to lapse between the reference time and the alignment time during the scan cycle, determine a time offset for triggering the TOF sensor to capture data associated with the exposure sequence; and
send, to the TOF sensor, a signal configured to trigger the TOF sensor to capture the data associated with the exposure sequence at a time associated with the time offset.
